(19) United States
(12) Patent Application Publication
(10) Pub. No.: US 2019/0180467 A1
(43) Pub. Date: Jun. 13, 2019

(54) SYSTEMS AND METHODS FOR IDENTIFYING AND POSITIONING OBJECTS AROUND A VEHICLE

(71) Applicant: BEIJING DIDI INFINITY TECHNOLOGY AND DEVELOPMENT CO., LTD., Beijing (CN)

(72) Inventors: Jian LI, Beijing (CN); Zhenzhe YING, Beijing (CN)

(73) Assignee: BEIJING DIDI INFINITY TECHNOLOGY AND DEVELOPMENT CO., LTD., Beijing (CN)

(21) Appl. No.: 16/234,701

(22) Filed: Dec. 28, 2018

Related U.S. Application Data
(63) Continuation of application No. PCT/CN2017/115491, filed on Dec. 11, 2017.

(51) Int. Cl. G06T 7/70; G01S 17/93; G06K 9/00; G06T 7/521

(52) U.S. Cl. CPC G06T 7/70; G01S 17/93; G06T 2207/30261; G06T 7/521; G06T 2207/10028; G06K 9/00805

(57) ABSTRACT

a Systems and methods for identifying and positioning one or more objects around a vehicle are provided. The method may include obtaining a first light detection and ranging (LiDAR) point cloud image around a detection base station. The method may further include identifying one or more objects in the first LiDAR point cloud image and determining one or more locations of the one or more objects in the first LiDAR point image. The method may further include generating a 3D shape for each of the one or more objects; and generating a second LiDAR point cloud image by marking the one or more objects in the first LiDAR point cloud image based on the locations and the 3D shapes of the one or more objects.

### CROSS-REFERENCE TO RELATED APPLICATIONS

This application is a continuation of International Application No. PCT/CN2017/115491, filed on Dec. 11, 2017, the entire contents of which are hereby incorporated by reference.

### TECHNICAL FIELD

The present disclosure generally relates to object identification, and in particular, to methods and systems for identifying and positioning objects around a vehicle during autonomous driving.

### BACKGROUND

Autonomous driving technology is developing rapidly in recent years. Vehicles using autonomous driving technology may sense its environment and navigate automatically. Some of the autonomous vehicles still require human's input and work as a driving aid. Some of the autonomous vehicles drives completely on their own. However, the ability of correctly identifying and positioning objects around the vehicle is important for any type of autonomous vehicles. The conventional method may include mounting a camera on the vehicle and analyzing the objects in images captured by the camera. However, the camera images are normally 2-dimentional (2D) and hence depth information of objects cannot be obtained easily. A radio detection and ranging (Radar) and a Light Detection and Ranging (LiDAR) device may be employed to obtain 3-dimentional (3D) images around the vehicle, but the objects therein are generally mixed with noises and difficult to be identified and positioned. Also, images generated by Radar and LiDAR device are difficult for humans to understand.

### SUMMARY

In one aspect of the present disclosure, a system for driving aid is provided. The system may include a control unit including one or more storage media including a set of instructions for identifying and positioning one or more objects around a vehicle, and one or more microchips electronically connected to the one or more storage media. During operation of the system, the one or more microchips may execute the set of instructions to obtain a first light detection and ranging (LiDAR) point cloud image around a detection base station; The one or more microchips may further execute the set of instructions to identify one or more objects in the first LiDAR point cloud image and determine one or more locations of the one or more objects in the first LiDAR point image. The one or more microchips may further execute the set of instructions to generate a 3D shape for each of the one or more objects, and generate a second LiDAR point cloud image by marking the one or more objects in the first LiDAR point cloud image based on the locations and the 3D shapes of the one or more objects.

In some embodiments, the system may further include at least one LiDAR device in communication with the control unit to send the LiDAR point cloud image to the control unit, at least one camera in communication with the control unit to send a camera image to the control unit, and at least one radar device in communication with the control unit to send a radar image to the control unit.

In some embodiments, the base station may be a vehicle, and the system may further include at least one LiDAR device mounted on a steering wheel, a cowl or reflector of the vehicle, wherein the mounting of the at least one LiDAR device may include at least one of an adhesive bonding, a bolt and nut connection, a bayonet fitting, or a vacuum fixation.

In some embodiments, the one or more microchips may further obtain a first camera image including at least one of the one or more objects, identify at least one target object of the one or more objects in the first camera image and at least one target location of the at least one target object in the first camera image, and generate a second camera image by marking the at least one target object in the first camera image based on the at least one target location in the first camera image and the 3D shape of the at least one target object in the LiDAR point cloud image.

In some embodiments, in marking the at least one target object in the first camera image, the one or more microchips may further obtain a 2D shape of the at least one target object in the first camera image, correlate the LiDAR point cloud image with the first camera image, generate a 3D shape of the at least one target object in the first camera image based on the 2D shape of the at least one target object and the correlation between the LiDAR point cloud image and the first camera image, and generate a second camera image by marking the at least one target object in the first camera image based on the identified location in the first camera image and the 3D shape of the at least one target object in the first camera image.

In some embodiments, to identify the at least one target object in the first camera image and the location of the at least one target object in the first camera image, the one or more microchips may operate a you only look once (YOLO) network or a Tiny-YOLO network to identify the at least one target object in the first camera image and the location of the at least one target object in the first camera image.

In some embodiments, to identify the one or more objects in the first LiDAR point cloud image, the one or more microchips may further obtain coordinates of a plurality of points in the first LiDAR point cloud image, wherein the plurality of points includes uninterested points and remaining points, remove the uninterested points from the plurality of points according to the coordinates, cluster the remaining points into one or more clusters based on a point cloud clustering algorithm, and select at least one of the one or more clusters as a target cluster, each of the target cluster corresponding to an object.

In some embodiments, to generate a 3D shape for each of the one or more objects, the one or more microchips may further determine a preliminary 3D shape of the object, adjust at least one of a height, a width, a length, a yaw, or an orientation of the preliminary 3D shape to generate a 3D shape proposal, calculate a score of the 3D shape proposal, and determine whether the score of the 3D shape proposal satisfies a preset condition. In response to the determination that the score of the 3D shape proposal does not satisfy a preset condition, the one or more microchips may further adjust the 3D shape proposal. In response to the determination that the score of the 3D shape proposal or further adjusted 3D shape proposal satisfies the preset condition, the one or more microchips may determine the 3D shape proposal or further adjusted 3D shape proposal as the 3D shape of the object.

In some embodiments, the score of the 3D shape proposal is calculated based on at least one of a number of points of the first LiDAR point cloud image inside the 3D shape proposal, a number of points of the first LiDAR point cloud image outside the 3D shape proposal, or distances between points and the 3D shape.

In some embodiments, the one or more microchips may further obtain a first radio detection and ranging (Radar) image around the detection base station, identify the one or more objects in the first Radar image, determine one or more locations of the one or more objects in the first Radar image, generate a 3D shape for each of the one or more objects in the first Radar image, generate a second Radar image by marking the one or more objects in the first Radar image based on the locations and the 3D shapes of the one or more objects in the first Radar image, and fuse the second Radar image and the second LiDAR point cloud image to generate a compensated image.

In some embodiments, the one or more microchips may further obtain two first LiDAR point cloud images around the base station at two different time frames, generate two second LiDAR point cloud images at the two different time frames based on the two first LiDAR point cloud images, and generate a third LiDAR point cloud image at a third time frame based on the two second LiDAR point cloud images by an interpolation method.

In some embodiments, the one or more microchips may further obtain a plurality of LiDAR point cloud images around the base station at a plurality of different time frames; generate a plurality of second LiDAR point cloud images at the plurality of different time frames based on the plurality of first LiDAR point cloud images; and generate a video based on the plurality of second LiDAR point cloud images.

In another aspect of the present disclosure, a method is provided. The method may be implemented on a computing device having one or more storage media storing instructions for identifying and positioning one or more objects around a vehicle, and one or more microchips electronically connected to the one or more storage media. The method may include obtaining a first light detection and ranging (LiDAR) point cloud image around a detection base station. The method may further include identifying one or more objects in the first LiDAR point cloud image, and determining one or more locations of the one or more objects in the first LiDAR point image. The method may further include generating a 3D shape for each of the one or more objects, and generating a second LiDAR point cloud image by marking the one or more objects in the first LiDAR point cloud image based on the locations and the 3D shapes of the one or more objects.

In another aspect of the present disclosure, a non-transitory computer readable medium is provided. The non-transitory computer readable medium may include at least one set of instructions for identifying and positioning one or more objects around a vehicle. When executed by microchips of an electronic terminal, the at least one set of instructions may direct the microchips to perform acts of obtaining a first light detection and ranging (LiDAR) point cloud image around a detection base station. The at least one set of instructions may further direct the microchips to perform acts of identifying one or more objects in the first LiDAR point cloud image, and determining one or more locations of the one or more objects in the first LiDAR point image. The at least one set of instructions may further direct the microchips to perform acts of generating a 3D shape for each of the one or more objects, and generating a second LiDAR point cloud image by marking the one or more objects in the first LiDAR point cloud image based on the locations and the 3D shapes of the one or more objects.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary scenario for autonomous vehicle according to some embodiments of the present disclosure;

FIG. 2 is a block diagram of an exemplary vehicle with an autonomous driving capability according to some embodiments of the present disclosure;

FIG. 3 is a schematic diagram illustrating exemplary hardware components of a computing device 300;

FIG. 4 is a block diagram illustrating an exemplary sensing module according to some embodiments of the present disclosure;

FIG. 5 is a flowchart illustrating an exemplary process for generating a LiDAR point cloud image on which 3D shape of objects are marked according to some embodiments of the present disclosure;

FIGS. 6A-6C are a series of schematic diagrams of generating and marking a 3D shape of an object in LiDAR point cloud image according to some embodiments of the present disclosure;

FIG. 7 is a flowchart illustrating an exemplary process for generating a marked camera image according to some embodiments of the present disclosure;

FIG. 8 is a flowchart illustrating an exemplary process for generating 2D representations of 3D shapes of the one or more objects in the camera image according to some embodiments of the present disclosure;

FIGS. 9A and 9B are schematic diagrams of same 2D camera images of a car according to some embodiments of the present disclosure;

FIG. 10 is a schematic diagram of a you only look once (yolo) network according to some embodiments of the present disclosure;

FIG. 11 is a flowchart illustrating an exemplary process for identifying the objects in a LiDAR point cloud image according to some embodiments of the present disclosure;

FIGS. 12A-12E are a series of schematic diagrams of identifying an object in a LiDAR point cloud image according to some embodiments of the present disclosure;

FIG. 13 is a flowchart illustrating an exemplary process for generating a 3D shape of an object in a LiDAR point cloud image according to some embodiments of the present disclosure;

FIGS. 14A-14D are a series of schematic diagrams of generating a 3D shape of an object in a LiDAR point cloud image according to some embodiments of the present disclosure;

FIG. 15 is a flow chart illustrating an exemplary process for generating a compensated image according to some embodiments of the present disclosure;

FIG. 16 is a schematic diagram of a synchronization between camera, LiDAR device, and/or radar device according to some embodiments of the present disclosure;

FIG. 17 is a flow chart illustrating an exemplary process for generating a LiDAR point cloud image or a video based on existing LiDAR point cloud images according to some embodiments of the present disclosure;

FIG. 18 is a schematic diagram of validating and interpolating frames of images according to some embodiments of the present disclosure;

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

In the present disclosure, the term “autonomous vehicle” may refer to a vehicle capable of sensing its environment and navigating without human (e.g., a driver, a pilot, etc.) input. The term “autonomous vehicle” and “vehicle” may be used interchangeably. The term “autonomous driving” may refer to ability of navigating without human (e.g., a driver, a pilot, etc.) input.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

Moreover, while the systems and methods disclosed in the present disclosure are described primarily regarding a driving aid for identifying and positioning objects around a vehicle, it should be understood that this is only one exemplary embodiment. The system or method of the present disclosure may be applied to any other kind of navigation system. For example, the system or method of the present disclosure may be applied to transportation systems of different environments including land, ocean, aerospace, or the like, or any combination thereof. The autonomous vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. In some embodiments, the system or method may find applications in, e.g., logistic warehousing, military affairs.

An aspect of the present disclosure relates to a driving aid for identifying and positioning objects around a vehicle during autonomous driving. For example, a camera, a LiDAR device, a Radar device may be mounted on a roof of an autonomous car. The camera, the LiDAR device and the Radar device may obtain a camera image, a LiDAR point cloud image, and a Radar image around the car respectively. The LiDAR point cloud image may include a plurality of points. A control unit may cluster the plurality of points into multiple clusters, wherein each cluster may correspond to an object. The control unit may determine a 3D shape for each object and mark the 3D shape on the LiDAR point cloud image. The control unit may also correlate the LiDAR point cloud image with the camera image to generate and mark a 2D representation of 3D shape of the objects on the camera image. The marked LiDAR point cloud image and camera image are better in understanding the location and movement of the objects. The control unit may further generate a video of the movement of the objects based on marked camera images. The vehicle or a driver therein may adjust speed and movement direction of the vehicle based on the generate video or images to avoid colliding the objects.

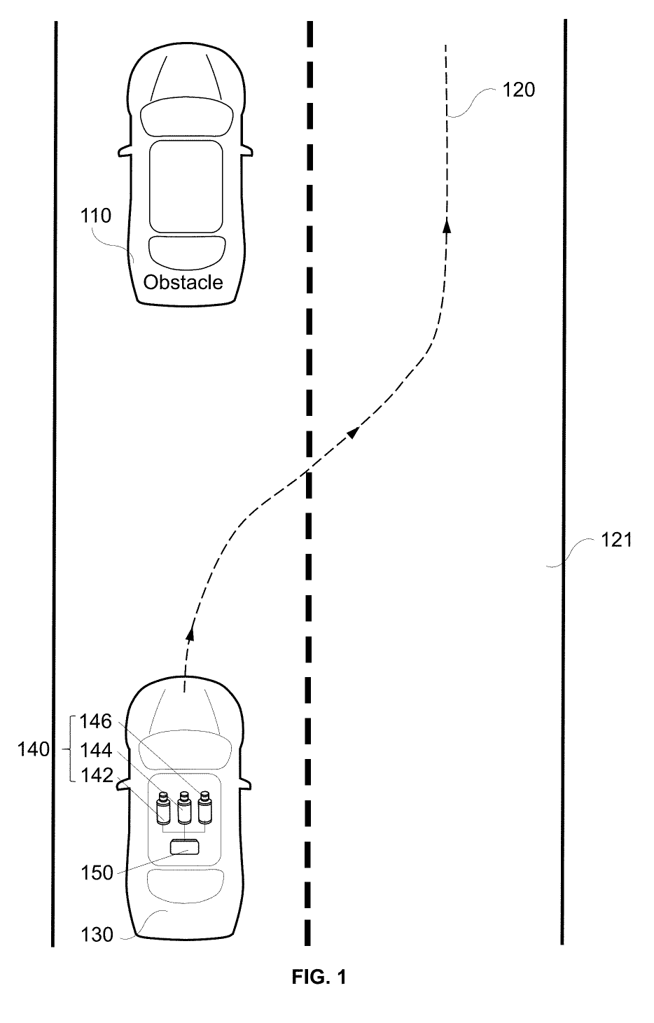

FIG. 1 is a schematic diagram illustrating an exemplary scenario for autonomous vehicle according to some embodiments of the present disclosure. As shown in FIG. 1, an autonomous vehicle 130 may travel along a road 121 without human input along a path autonomously determined by the autonomous vehicle 130. The road 121 may be a space prepared for a vehicle to travel along. For example, the road 121 may be a road for vehicles with wheel (e.g. a car, a train, a bicycle, a tricycle, etc.) or without wheel (e.g., a hovercraft), may be an air lane for an air plane or other aircraft, and may be a water lane for ship or submarine, may be an orbit for satellite. Travel of the autonomous vehicle 130 may not break traffic law of the road 121 regulated by law or regulation. For example, speed of the autonomous vehicle 130 may not exceed speed limit of the road 121.

The autonomous vehicle 130 may not collide an obstacle 110 by travelling along a path 120 determined by the autonomous vehicle 130. The obstacle 110 may be a static obstacle or a dynamic obstacle. The static obstacle may include a building, tree, roadblock, or the like, or any combination thereof. The dynamic obstacle may include moving vehicles, pedestrians, and/or animals, or the like, or any combination thereof.

The autonomous vehicle 130 may include conventional structures of a non-autonomous vehicle, such as an engine, four wheels, a steering wheel, etc. The autonomous vehicle 130 may further include a sensing system 140, including a plurality of sensors (e.g., a sensor 142, a sensor 144, a sensor 146) and a control unit 150. The plurality of sensors may be configured to provide information that is used to control the vehicle. In some embodiments, the sensors may sense status of the vehicle. The status of the vehicle may include dynamic situation of the vehicle, environmental information around the vehicle, or the like, or any combination thereof.

In some embodiments, the plurality of sensors may be configured to sense dynamic situation of the autonomous vehicle 130. The plurality of sensors may include a distance sensor, a velocity sensor, an acceleration sensor, a steering angle sensor, a traction-related sensor, a camera, and/or any sensor.

For example, the distance sensor (e.g., a radar, a LiDAR, an infrared sensor) may determine a distance between a vehicle (e.g., the autonomous vehicle 130) and other objects (e.g., the obstacle 110). The distance sensor may also determine a distance between a vehicle (e.g., the autonomous vehicle 130) and one or more obstacles (e.g., static obstacles, dynamic obstacles). The velocity sensor (e.g., a Hall sensor) may determine a velocity (e.g., an instantaneous velocity, an average velocity) of a vehicle (e.g., the autonomous vehicle 130). The acceleration sensor (e.g., an accelerometer) may determine an acceleration (e.g., an instantaneous acceleration, an average acceleration) of a vehicle (e.g., the autonomous vehicle 130). The steering angle sensor (e.g., a tilt sensor) may determine a steering angle of a vehicle (e.g., the autonomous vehicle 130). The traction -related sensor (e.g., a force sensor) may determine a traction of a vehicle (e.g., the autonomous vehicle 130).

In some embodiments, the plurality of sensors may sense environment around the autonomous vehicle 130. For example, one or more sensors may detect a road geometry and obstacles (e.g., static obstacles, dynamic obstacles). The road geometry may include a road width, road length, road type (e.g., ring road, straight road, one-way road, two-way road). The static obstacles may include a building, tree, roadblock, or the like, or any combination thereof. The dynamic obstacles may include moving vehicles, pedestrians, and/or animals, or the like, or any combination thereof. The plurality of sensors may include one or more video cameras, laser-sensing systems, infrared-sensing systems, acoustic-sensing systems, thermal -sensing systems, or the like, or any combination thereof.

The control unit 150 may be configured to control the autonomous vehicle 130. The control unit 150 may control the autonomous vehicle 130 to drive along a path 120. The control unit 150 may calculate the path 120 based on the status information from the plurality of sensors. In some embodiments, the path 120 may be configured to avoid collisions between the vehicle and one or more obstacles (e.g., the obstacle 110).

In some embodiments, the path 120 may include one or more path samples. Each of the one or more path samples may include a plurality of path sample features. The plurality of path sample features may include a path velocity, a path acceleration, a path location, or the like, or a combination thereof.

The autonomous vehicle 130 may drive along the path 120 to avoid a collision with an obstacle. In some embodiments, the autonomous vehicle 130 may pass each path location at a corresponding path velocity and a corresponding path accelerated velocity for each path location.

In some embodiments, the autonomous vehicle 130 may also include a positioning system to obtain and/or determine the position of the autonomous vehicle 130. In some embodiments, the positioning system may also be connected to another party, such as a base station, another vehicle, or another person, to obtain the position of the party. For example, the positioning system may be able to establish a communication with a positioning system of another vehicle, and may receive the position of the other vehicle and determine the relative positions between the two vehicles.

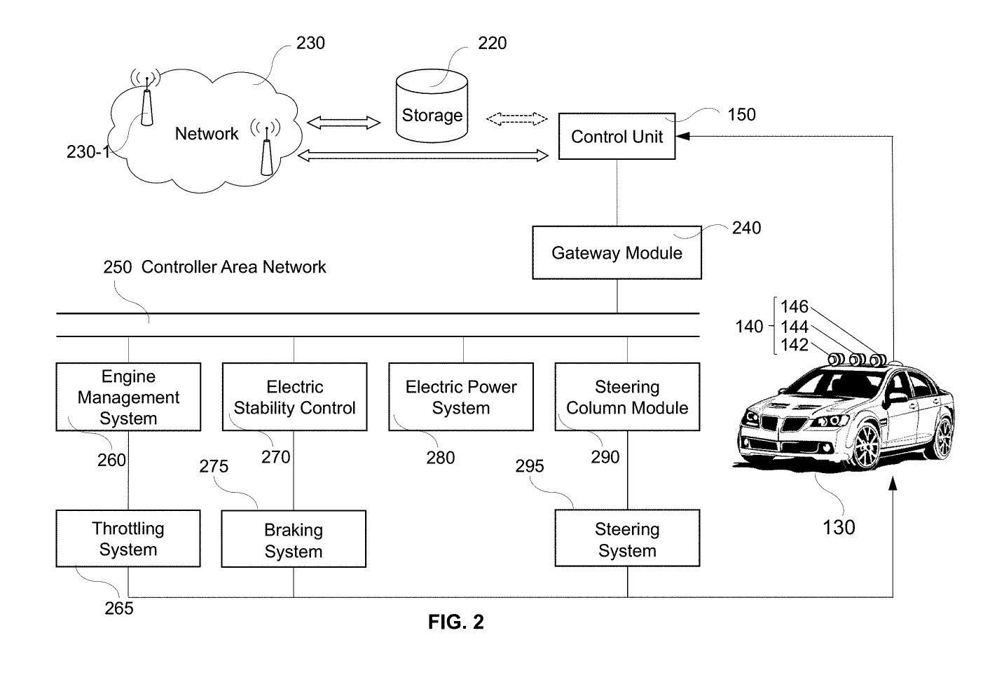

FIG. 2 is a block diagram of an exemplary vehicle with an autonomous driving capability according to some embodiments of the present disclosure. For example, the vehicle with an autonomous driving capability may include a control system, including but not limited to a control unit 150, a plurality of sensors 142, 144, 146, a storage 220, a network 230, a gateway module 240, a Controller Area Network (CAN) 250, an Engine Management System (EMS) 260, an Electric Stability Control (ESC) 270, an Electric Power System (EPS) 280, a Steering Column Module (SCM) 290, a throttling system 265, a braking system 275 and a steering system 295.

The control unit 150 may process information and/or data relating to vehicle driving (e.g., autonomous driving) to perform one or more functions described in the present disclosure. In some embodiments, the control unit 150 may be configured to drive a vehicle autonomously. For example, the control unit 150 may output a plurality of control signals. The plurality of control signal may be configured to be received by a plurality of electronic control units (ECUs) to control the drive of a vehicle. In some embodiments, the control unit 150 may determine a reference path and one or more candidate paths based on environment information of the vehicle. In some embodiments, the control unit 150 may include one or more processing engines (e.g., single-core processing engine(s) or multi-core processor(s)). Merely by way of example, the control unit 150 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The storage 220 may store data and/or instructions. In some embodiments, the storage 220 may store data obtained from the autonomous vehicle 130. In some embodiments, the storage 220 may store data and/or instructions that the control unit 150 may execute or use to perform exemplary methods described in the present disclosure. In some embodiments, the storage 220 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero -capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage may be implemented on a cloud platform. Merely by way of example, the cloud platform may include a private cloud, a public cloud, a hybrid cloud, a community cloud, a distributed cloud, an inter -cloud, a multi-cloud, or the like, or any combination thereof.

In some embodiments, the storage 220 may be connected to the network 230 to communicate with one or more components of the autonomous vehicle 130 (e.g., the control unit 150, the sensor 142). One or more components in the autonomous vehicle 130 may access the data or instructions stored in the storage 220 via the network 230. In some embodiments, the storage 220 may be directly connected to or communicate with one or more components in the autonomous vehicle 130 (e.g., the control unit 150, the sensor 142). In some embodiments, the storage 220 may be part of the autonomous vehicle 130.

The network 230 may facilitate exchange of information and/or data. In some embodiments, one or more components in the autonomous vehicle 130 (e.g., the control unit 150, the sensor 142) may send information and/or data to other component(s) in the autonomous vehicle 130 via the network 230. For example, the control unit 150 may obtain/acquire dynamic situation of the vehicle and/or environment information around the vehicle via the network 230. In some embodiments, the network 230 may be any type of wired or wireless network, or combination thereof. Merely by way of example, the network 230 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 230 may include one or more network access points. For example, the network 230 may include wired or wireless network access points such as base stations and/or internet exchange points 230-1, . . . , through which one or more components of the autonomous vehicle 130 may be connected to the network 230 to exchange data and/or information.

The gateway module 240 may determine a command source for the plurality of ECUs (e.g., the EMS 260, the EPS 280, the ESC 270, the SCM 290) based on a current driving status of the vehicle. The command source may be from a human driver, from the control unit 150, or the like, or any combination thereof.

The gateway module 240 may determine the current driving status of the vehicle. The driving status of the vehicle may include a manual driving status, a semi-autonomous driving status, an autonomous driving status, an error status, or the like, or any combination thereof. For example, the gateway module 240 may determine the current driving status of the vehicle to be a manual driving status based on an input from a human driver. For another example, the gateway module 240 may determine the current driving status of the vehicle to be a semi-autonomous driving status when the current road condition is complex. As still another example, the gateway module 240 may determine the current driving status of the vehicle to be an error status when abnormalities (e.g., a signal interruption, a processor crash) happen.

In some embodiments, the gateway module 240 may transmit operations of the human driver to the plurality of ECUs in response to a determination that the current driving status of the vehicle is a manual driving status. For example, the gateway module 240 may transmit a press on the accelerator done by the human driver to the EMS 260 in response to a determination that the current driving status of the vehicle is a manual driving status. The gateway module 240 may transmit the control signals of the control unit 150 to the plurality of ECUs in response to a determination that the current driving status of the vehicle is an autonomous driving status. For example, the gateway module 240 may transmit a control signal associated with steering to the SCM 290 in response to a determination that the current driving status of the vehicle is an autonomous driving status. The gateway module 240 may transmit the operations of the human driver and the control signals of the control unit 150 to the plurality of ECUs in response to a determination that the current driving status of the vehicle is a semi -autonomous driving status. The gateway module 240 may transmit an error signal to the plurality of ECUs in response to a determination that the current driving status of the vehicle is an error status.

A Controller Area Network (CAN bus) is a robust vehicle bus standard (e.g., a message-based protocol) allowing microcontrollers (e.g., the control unit 150) and devices (e.g., the EMS 260, the EPS 280, the ESC 270, and/or the SCM 290, etc.) to communicate with each other in applications without a host computer. The CAN 250 may be configured to connect the control unit 150 with the plurality of ECUs (e.g., the EMS 260, the EPS 280, the ESC 270, the SCM 290).

The EMS 260 may be configured to determine an engine performance of the autonomous vehicle 130. In some embodiments, the EMS 260 may determine the engine performance of the autonomous vehicle 130 based on the control signals from the control unit 150. For example, the EMS 260 may determine the engine performance of the autonomous vehicle 130 based on a control signal associated with an acceleration from the control unit 150 when the current driving status is an autonomous driving status. In some embodiments, the EMS 260 may determine the engine performance of the autonomous vehicle 130 based on operations of a human driver. For example, the EMS 260 may determine the engine performance of the autonomous vehicle 130 based on a press on the accelerator done by the human driver when the current driving status is a manual driving status.

The EMS 260 may include a plurality of sensors and a micro -processor. The plurality of sensors may be configured to detect one or more physical signals and convert the one or more physical signals to electrical signals for processing. In some embodiments, the plurality of sensors may include a variety of temperature sensors, an air flow sensor, a throttle position sensor, a pump pressure sensor, a speed sensor, an oxygen sensor, a load sensor, a knock sensor, or the like, or any combination thereof. The one or more physical signals may include an engine temperature, an engine intake air volume, a cooling water temperature, an engine speed, or the like, or any combination thereof. The micro-processor may determine the engine performance based on a plurality of engine control parameters. The micro -processor may determine the plurality of engine control parameters based on the plurality of electrical signals. The plurality of engine control parameters may be determined to optimize the engine performance. The plurality of engine control parameters may include an ignition timing, a fuel delivery, an idle air flow, or the like, or any combination thereof.

The throttling system 265 may be configured to change motions of the autonomous vehicle 130. For example, the throttling system 265 may determine a velocity of the autonomous vehicle 130 based on an engine output. For another example, the throttling system 265 may cause an acceleration of the autonomous vehicle 130 based on the engine output. The throttling system 365 may include fuel injectors, a fuel pressure regulator, an auxiliary air valve, a temperature switch, a throttle, an idling speed motor, a fault indicator, ignition coils, relays, or the like, or any combination thereof.

In some embodiments, the throttling system 265 may be an external executor of the EMS 260. The throttling system 265 may be configured to control the engine output based on the plurality of engine control parameters determined by the EMS 260.

The ESC 270 may be configured to improve the stability of the vehicle. The ESC 270 may improve the stability of the vehicle by detecting and reducing loss of traction. In some embodiments, the ESC 270 may control operations of the braking system 275 to help steer the vehicle in response to a determination that a loss of steering control is detected by the ESC 270. For example, the ESC 270 may improve the stability of the vehicle when the vehicle starts on an uphill slope by braking. In some embodiments, the ESC 270 may further control the engine performance to improve the stability of the vehicle. For example, the ESC 270 may reduce an engine power when a probable loss of steering control happens. The loss of steering control may happen when the vehicle skids during emergency evasive swerves, when the vehicle understeers or oversteers during poorly judged turns on slippery roads, etc.

The braking system 275 may be configured to control a motion state of the autonomous vehicle 130. For example, the braking system 275 may decelerate the autonomous vehicle 130. For another example, the braking system 275 may stop the autonomous vehicle 130 in one or more road conditions (e.g., a downhill slope). As still another example, the braking system 275 may keep the autonomous vehicle 130 at a constant velocity when driving on a downhill slope.

The braking system 275 man include a mechanical control component, a hydraulic unit, a power unit (e.g., a vacuum pump), an executing unit, or the like, or any combination thereof. The mechanical control component may include a pedal, a handbrake, etc. The hydraulic unit may include a hydraulic oil, a hydraulic hose, a brake pump, etc. The executing unit may include a brake caliper, a brake pad, a brake disc, etc.

The EPS 280 may be configured to control electric power supply of the autonomous vehicle 130. The EPS 280 may supply, transfer, and/or store electric power for the autonomous vehicle 130. In some embodiments, the EPS 280 may control power supply to the steering system 295. For example, the EPS 280 may supply a large electric power to the steering system 295 to create a large steering torque for the autonomous vehicle 130, in response to a determination that a steering wheel is turned to a limit (e.g., a left turn limit, a right turn limit).

The SCM 290 may be configured to control the steering wheel of the vehicle. The SCM 290 may lock/unlock the steering wheel of the vehicle. The SCM 290 may lock/unlock the steering wheel of the vehicle based on the current driving status of the vehicle. For example, the SCM 290 may lock the steering wheel of the vehicle in response to a determination that the current driving status is an autonomous driving status. The SCM 290 may further retract a steering column shaft in response to a determination that the current driving status is an autonomous driving status. For another example, the SCM 290 may unlock the steering wheel of the vehicle in response to a determination that the current driving status is a semi-autonomous driving status, a manual driving status, and/or an error status.

The SCM 290 may control the steering of the autonomous vehicle 130 based on the control signals of the control unit 150. The control signals may include information related to a turning direction, a turning location, a turning angle, or the like, or any combination thereof.

The steering system 295 may be configured to steer the autonomous vehicle 130. In some embodiments, the steering system 295 may steer the autonomous vehicle 130 based on signals transmitted from the SCM 290. For example, the steering system 295 may steer the autonomous vehicle 130 based on the control signals of the control unit 150 transmitted from the SCM 290 in response to a determination that the current driving status is an autonomous driving status. In some embodiments, the steering system 295 may steer the autonomous vehicle 130 based on operations of a human driver. For example, the steering system 295 may turn the autonomous vehicle 130 to a left direction when the human driver turns the steering wheel to a left direction in response to a determination that the current driving status is a manual driving status.

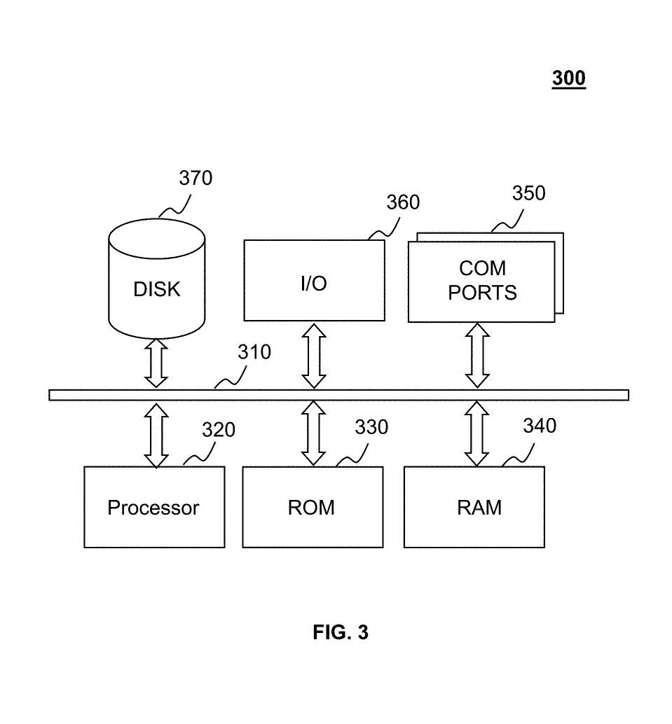

FIG. 3 is a schematic diagram illustrating exemplary hardware components of a computing device 300.

The computing device 300 may be a special purpose computing device for autonomous driving, such as a single-board computing device including one or more microchips. Further, the control unit 150 may include one or more of the computing device 300. The computing device 300 may be used to implement the method and/or system described in the present disclosure via its hardware, software program, firmware, or a combination thereof.

The computing device 300, for example, may include COM ports 350 connected to and from a network connected thereto to facilitate data communications. The computing device 300 may also include a processor 320, in the form of one or more processors, for executing computer instructions. The computer instructions may include, for example, routines, programs, objects, components, data structures, procedures, modules, and functions, which perform particular functions described herein. For example, during operation, the processor 320 may access instructions for operating the autonomous vehicle 130 and execute the instructions to determine a driving path for the autonomous vehicle.

In some embodiments, the processor 320 may include one or more hardware processors built in one or more microchips, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

The exemplary computer device 300 may include an internal communication bus 310, program storage and data storage of different forms, for example, a disk 270, and a read only memory (ROM) 330, or a random access memory (RAM) 340, for various data files to be processed and/or transmitted by the computer. The exemplary computer device 300 may also include program instructions stored in the ROM 330, RAM 340, and/or other type of non-transitory storage medium to be executed by the processor 320. The methods and/or processes of the present disclosure may be implemented as the program instructions. The computing device 300 also includes an I/O component 360, supporting input/output between the computer and other components (e.g., user interface elements). The computing device 300 may also receive programming and data via network communications.

Merely for illustration, only one processor is described in the computing device 300. However, it should be noted that the computing device 300 in the present disclosure may also include multiple processors, thus operations and/or method steps that are performed by one processor as described in the present disclosure may also be jointly or separately performed by the multiple processors. For example, if in the present disclosure the processor 320 of the computing device 300 executes both step A and step B, it should be understood that step A and step B may also be performed by two different processors jointly or separately in the computing device 300 (e.g., the first processor executes step A and the second processor executes step B, or the first and second processors jointly execute steps A and B).

Also, one of ordinary skill in the art would understand that when an element in the control system in FIG. 2 performs, the element may perform through electrical signals and/or electromagnetic signals. For example, when a sensor 142, 144, or 146 sends out detected information, such as a digital photo or a LiDAR cloud point image, the information may be transmitted to a receiver in a form of electronic signals. The control unit 150 may receive the electronic signals of the detected information and may operate logic circuits in its processor to process such information. When the control unit 150 sends out a command to the CAN 250 and/or the gateway module 240 to control the EMS 260, ESC 270, EPS 280 etc., a processor of the control unit 159 may generate electrical signals encoding the command and then send the electrical signals to an output port. Further, when the processor retrieves data from a storage medium, it may send out electrical signals to a read device of the storage medium, which may read structured data in the storage medium. The structured data may be transmitted to the processor in the form of electrical signals via a bus of the control unit 150. Here, an electrical signal may refer to one electrical signal, a series of electrical signals, and/or a plurality of discrete electrical signals.

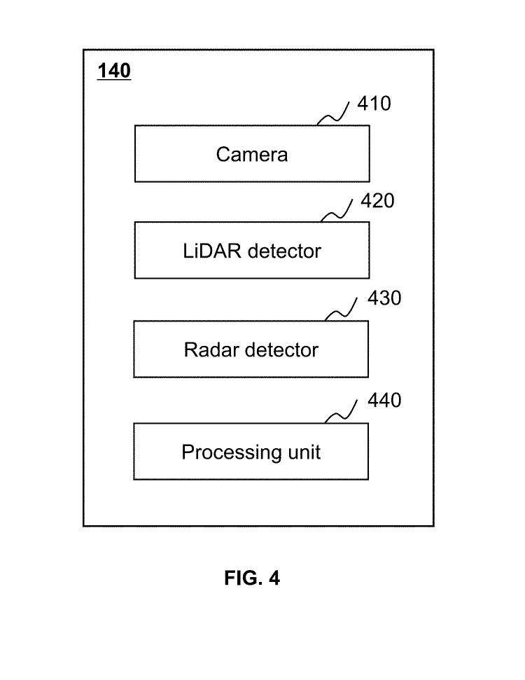

FIG. 4 is a block diagram illustrating an exemplary sensing system according to some embodiments of the present disclosure. The sensing system 140 may be in communication with a control unit 150 to send raw sensing data (e.g., images) or preprocessed sensing data to the control unit 150. In some embodiments, the sensing system 140 may include at least one camera 410, at least one LiDAR detector 420, at least radar detector 430, and a processing unit 440. In some embodiments, the camera 410, the LiDAR detector 420, and the radar detector 430 may correspond to the sensors 142, 144, and 146, respectively.

The camera 410 may be configured to capture camera image(s) of environmental data around a vehicle. The camera 410 may include an unchangeable lens camera, a compact camera, a 3D camera, a panoramic camera, an audio camera, an infrared camera, a digital camera, or the like, or any combination thereof. In some embodiments, multiple cameras of the same or different types may be mounted on a vehicle. For example, an infrared camera may be mounted on a back hood of the vehicle to capture infrared images of objects behind the vehicle, especially, when the vehicle is backing up at night. As another example, an audio camera may be mounted on a reflector of the vehicle to capture images of objects at a side of the vehicle. The audio camera may mark a sound level of different sections or objects on the images obtained. In some embodiments, the images captured by the multiple cameras 410 mounted on the vehicle may collectively cover a whole region around the vehicle.

Merely by way of example, the multiple cameras 410 may be mounted on different parts of the vehicle, including but not limited to a window, a car body, a rear-view mirror, a handle, a light, a sunroof and a license plate. The window may include a front window, a back window, a side window, etc. The car body may include a front hood, a back hood, a roof, a chassis, a side, etc. In some embodiments, the multiple cameras 410 may be attached to or mounted on accessories in the compartment of the vehicle (e.g., a steering wheel, a cowl, a reflector). The method of mounting may include adhesive bonding, bolt and nut connection, bayonet fitting, vacuum fixation, or the like, or any combination thereof.

The LiDAR device 420 may be configured to obtain high resolution images with certain range from the vehicle. For example, the LiDAR device 420 may be configured to detect objects within 35 meters of the vehicle.

The LiDAR device 420 may be configured to generate LiDAR point cloud images of the surrounding environment of the vehicle to which the LiDAR device 420 is mounted. The LiDAR device 420 may include a laser generator and a sensor. The laser beam may include an ultraviolet light, a visible light, a near infrared light, etc. The laser generator may illuminate the objects with a pulsed laser beam at a fixed predetermine frequency or predetermined varying frequencies. The laser beam may reflect back after contacting the surface of the objects and the sensor may receive the reflected laser beam. Through the reflected laser beam, the LiDAR device 420 may measure the distance between the surface of the objects and the LiDAR device 420. During operation, the LiDAR device 420 may rotate and use the laser beam to scan the surrounding environment of the vehicle, thereby generating a LiDAR point cloud image according to the reflected laser beam. Since the LiDAR device 420 rotates and scans along limited heights of the vehicle's surrounding environment, the LiDAR point cloud image measures the 360° environment surrounding the vehicle between the predetermined heights of the vehicle. The LiDAR point cloud image may be a static or dynamic image. Further, since each point in the LiDAR point cloud image measures the distance between the LiDAR device and a surface of an object from which the laser beam is reflected, the LiDAR point cloud image is a 3D image. In some embodiments, the LiDAR point cloud image may be a real -time image illustrating a real-time propagation of the laser beam.

Merely by way of example, the LiDAR device 420 may be mounted on the roof or front window of the vehicle, however, it should be noted that the LiDAR device 420 may also be installed on other parts of the vehicle, including but not limited to a window, a car body, a rear-view mirror, a handle, a light, a sunroof and a license plate.

The radar device 430 may be configured to generate a radar image by measuring distance to objects around a vehicle via radio waves. Comparing with LiDAR device 420, the radar device 430 may be less precise (with less resolution) but may have a wider detection range. Accordingly, the radar device 430 may be used to measure objects farther than the detection range of the LiDAR device 420. For example, the radar device 430 may be configured to measure objects between 35 meters and 100 meters from the vehicle.

The radar device 430 may include a transmitter for producing electromagnetic waves in the radio or microwaves domain, a transmitting antenna for transmitting or broadcasting the radio waves, a receiving antenna for receiving the radio waves and a processor for generating a radar image. Merely by way of example, the radar device 430 may be mounted on the roof or front window of the vehicle, however, it should be noted that the radar device 430 may also be installed on other parts of the vehicle, including but not limited to a window, a car body, a rear-view mirror, a handle, a light, a sunroof and a license plate.

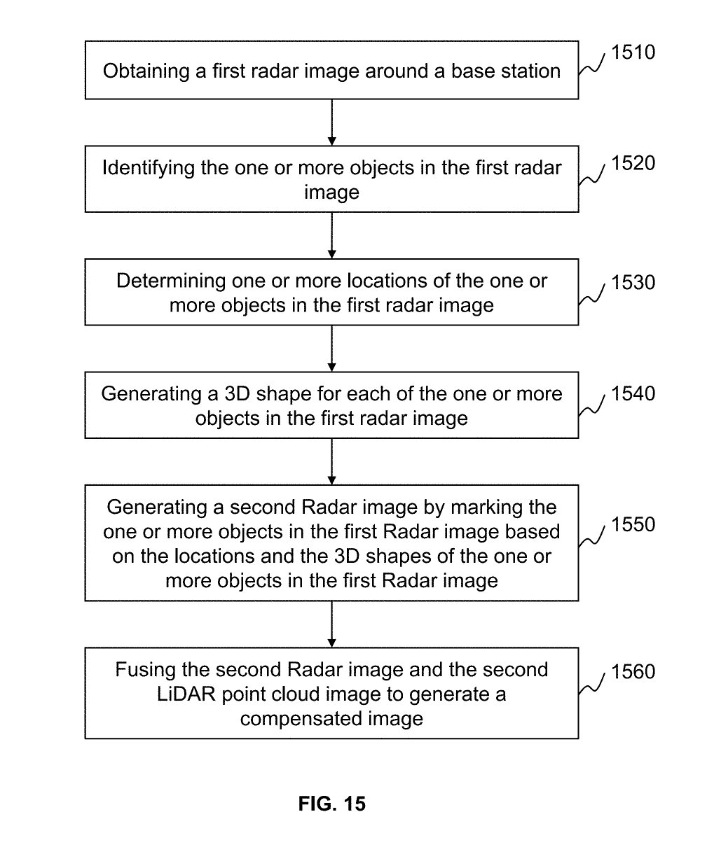

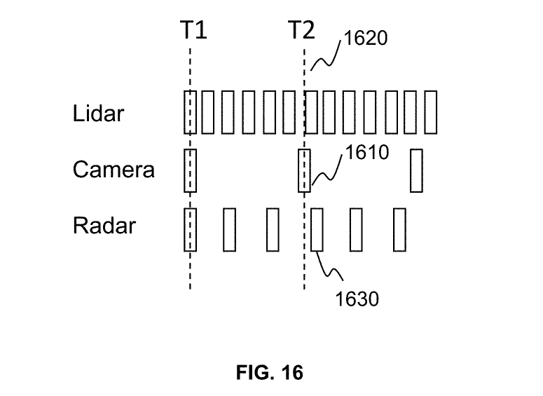

In some embodiments, the LiDAR image and the radar image may be fused to generate a compensated image. Detailed methods regarding the fusion of the LiDAR image and the radar image may be found elsewhere in present disclosure (See, e.g., FIG. 15 and the descriptions thereof). In some embodiments, the camera 410, the LiDAR device 420 and the radar device 430 may work concurrently or individually. In a case that they are working individually at different time frame rates, a synchronization method may be employed. Detailed method regarding the synchronization of the frames of the camera 410, the LiDAR device 420 and/or the radar device 430 may be found elsewhere in the present disclosure (See e.g., FIG. 16 and the descriptions thereof).

The sensing system 140 may further include a processing unit 440 configured to pre-process the generated images (e.g., camera image, LiDAR image, and radar image). In some embodiments, the pre-processing of the images may include smoothing, filtering, denoising, reconstructing, or the like, or any combination thereof.

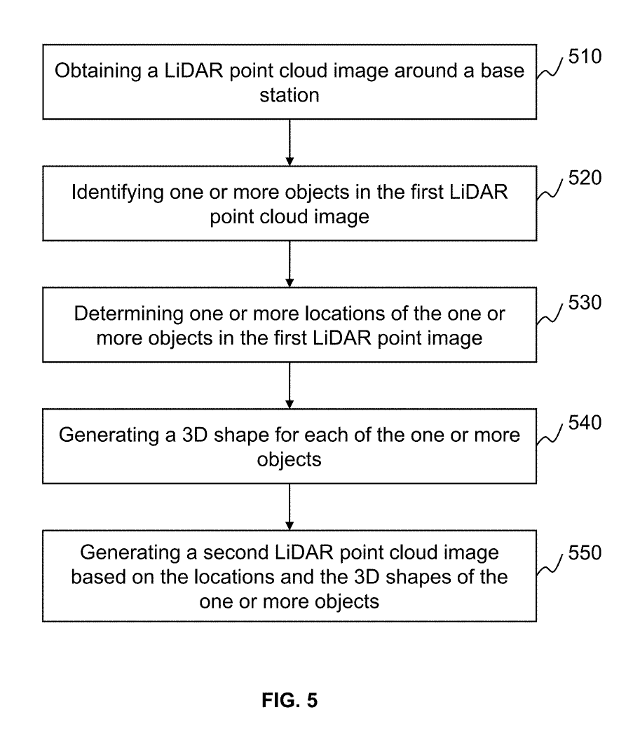

FIG. 5 is a flowchart illustrating an exemplary process for generating a LiDAR point cloud image on which 3D shape of objects are marked according to some embodiments of the present disclosure. In some embodiments, the process 500 may be implemented in the autonomous vehicle as illustrated in FIG. 1. For example, the process 500 may be stored in the storage 220 and/or other storage (e.g., the ROM 330, the RAM 340) as a form of instructions, and invoked and/or executed by a processing unit (e.g., the processor 320, the control unit 150, one or more microchips of the control unit 150). The present disclosure takes the control unit 150 as an example to execute the instruction.

In 510, the control unit 150 may obtain a LiDAR point cloud image (also referred to as a first LiDAR point cloud image) around a base station.

The base station may be any device that the LiDAR device, the radar, and the camera are mounted on. For example, the base station may be a movable platform, such as a vehicle (e.g., a car, an aircraft, a ship etc.). The base station may also be a stationary platform, such as a detection station or a airport control tower. Merely for illustration purpose, the present disclosure takes a vehicle or a device (e.g., a rack) mounted on the vehicle as an example of the base station.

The first LiDAR point cloud image may be generated by the LiDAR device 420. The first LiDAR point cloud image may be a 3D point cloud image including voxels corresponding to one or more objects around the base station. In some embodiments, the first LiDAR point cloud image may correspond to a first time frame (also referred to as a first time point).

In 520, the control unit 150 may identify one or more objects in the first LiDAR point cloud image.

The one or more objects may include pedestrians, vehicles, obstacles, buildings, signs, traffic lights, animals, or the like, or any combination thereof. In some embodiments, the control unit 150 may identify the regions and types of the one or more objects in 520. In some embodiments, the control unit 150 may only identify the regions. For example, the control unit 150 may identify a first region of the LiDAR point cloud image as a first object, a second region of the LiDAR point cloud image as a second object and remaining regions as ground (or air). As another example, the control unit 150 may identify the first region as a pedestrian and the second region as a vehicle.

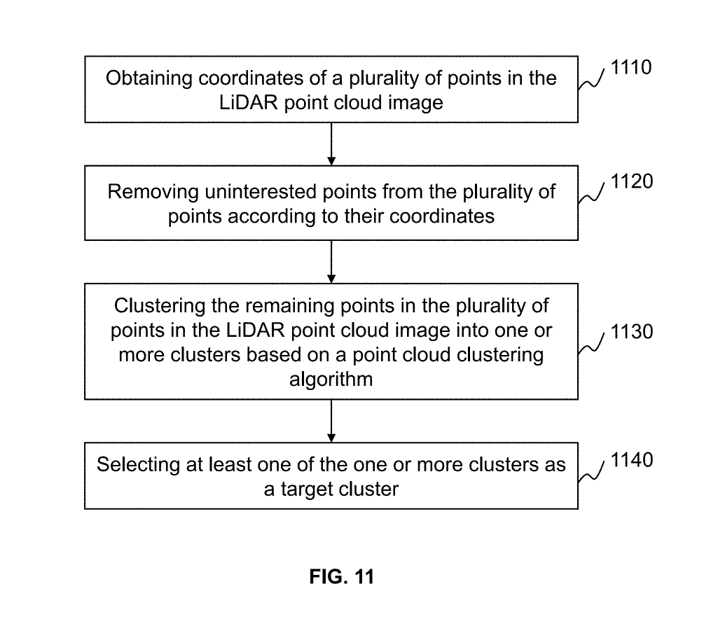

In some embodiments, if the current method is employed by a vehicle -mounted device as a way of driving aid, control unit 150 may first determine the height of the points (or voxels) around the vehicle-mounted base station (e.g., the height of the vehicle where the vehicle-mounted device is plus the height of the vehicle mounted device). The points that are too low (ground), or too high (e.g., at a height that is unlikely to be an object to avoid or to consider during driving) may be removed by the control unit 150 before identifying the one or more objects. The remaining points may be clustered into a plurality of clusters. In some embodiments, the remaining points may be clustered based on their 3D coordinates (e.g., cartesian coordinates) in the 3D point cloud image (e.g., distance between points that are less than a threshold is clustered into a same cluster). In some embodiments, the remaining points may be swing scanned before clustered into the plurality of clusters. The swing scanning may include converting the remaining points in the 3D point cloud image from a 3D cartesian coordinate system to a polar coordinate system. The polar coordinate system may include an origin or a reference point. The polar coordinate of each of the remaining points may be expressed as a straight-line distance from the origin, and an angle from the origin to the point. A graph may be generated based on the polar coordinates of the remaining points (e.g., angle from the origin as x-axis or horizontal axis and distance from the origin as y-axis or vertical axis). The points in the graph may be connected to generate a curve that includes sections with large curvatures and sections with small curvatures. Points on a section with a small curvature are likely the points on a same object and may be clustered into a same cluster. Points on a section with a large curvature are likely the points on different objects and may be clustered into different clusters. Each cluster may correspond to an object. The method of identifying the one or more objects may be found in FIG. 11. In some embodiments, the control unit 150 may obtain a camera image that is taken at a same (or substantially the same or similar) time and angle as the first LiDAR point cloud image. The control unit 150 may identify the one or more objects in the camera image and directly treat them as the one or more objects in the LiDAR point cloud image.

In 530, the control unit 150 may determine one or more locations of the one or more objects in the first LiDAR point image. The control unit 150 may consider each identified object separately and perform operation 530 for each of the one or more objects individually. In some embodiments, the locations of the one or more objects may be a geometric center or gravity point of the clustered region of the one or more objects. In some embodiments, the locations of the one or more objects may be preliminary locations that are adjusted or re-determined after the 3D shape of the one or more objects are generated in 540. It should be noted that the operations 520 and 530 may be performed in any order, or combined as one operation. For example, the control unit 150 may determine locations of points corresponding to one or more unknown objects, cluster the points into a plurality of clusters and then identify the clusters as objects.

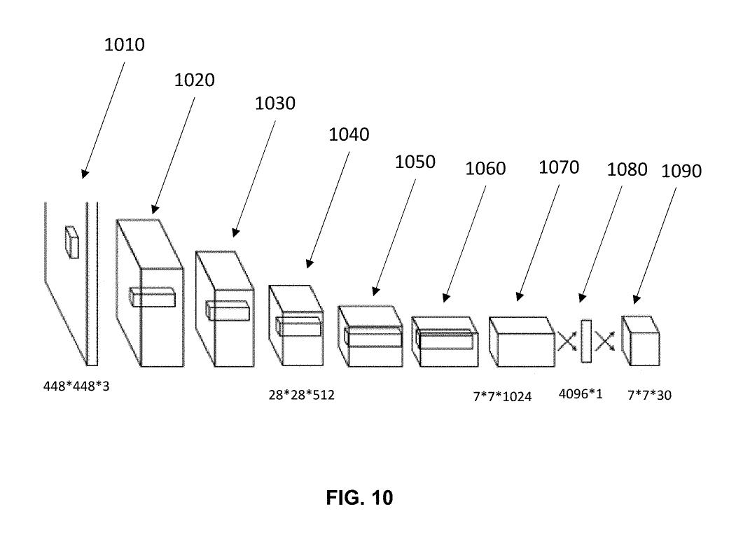

In some embodiments, the control unit 150 may obtain a camera image. The camera image may be taken by the camera at the same (or substantially the same, or similar) time and angle as the LiDAR point cloud image. The control unit 150 may determine locations of the objects in the camera image based on a neural network (e.g., a tiny yolo network as described in FIG. 10). The control unit 150 may determine the locations of the one or more objects in the LiDAR point cloud image by mapping locations in the camera image to the LiDAR point cloud image. The mapping of locations from a 2D camera image to a 3D LiDAR point cloud image may include a conic projection, etc.

In some embodiments, the operations 520 and 530 for identifying the objects and determining the locations of the objects may be referred to as a coarse detection.

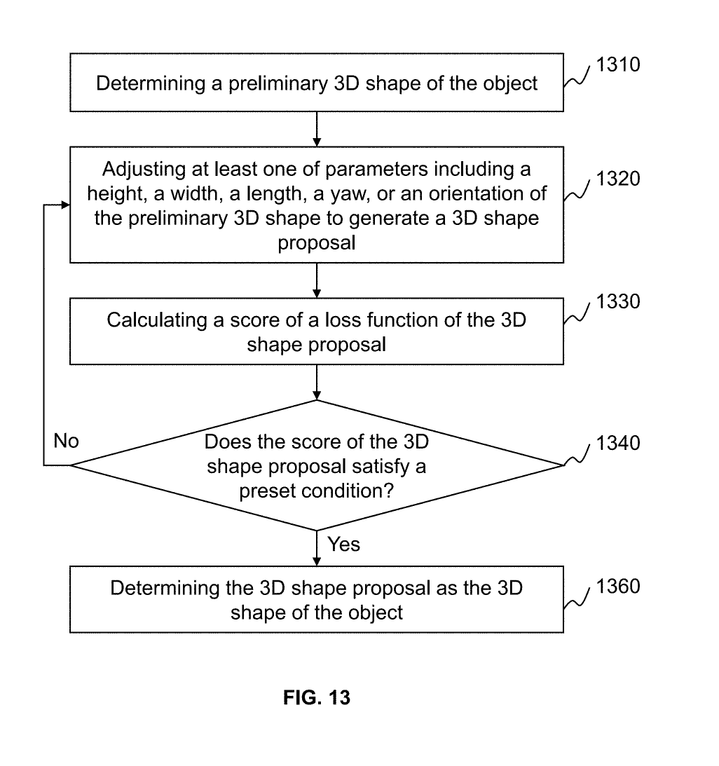

In 540, the control unit 150 may generate a 3D shape (e.g., a 3D box) for each of the one or more objects. Detailed methods regarding the generation of the 3D shape for each of the one or more objects may be found elsewhere in the present disclosure (See, e.g., FIG. 13 and the descriptions thereof). In some embodiments, the operation 540 for generating a 3D shape for the objects may be referred to as a fine detection.

In 550, the control unit 150 may generate a second LiDAR point cloud image based on the locations and the 3D shapes of the one or more objects. For example, the control unit 150 may mark the first LiDAR point cloud image by the 3D shapes of the one or more objects at their corresponding locations to generate the second LiDAR point cloud image.

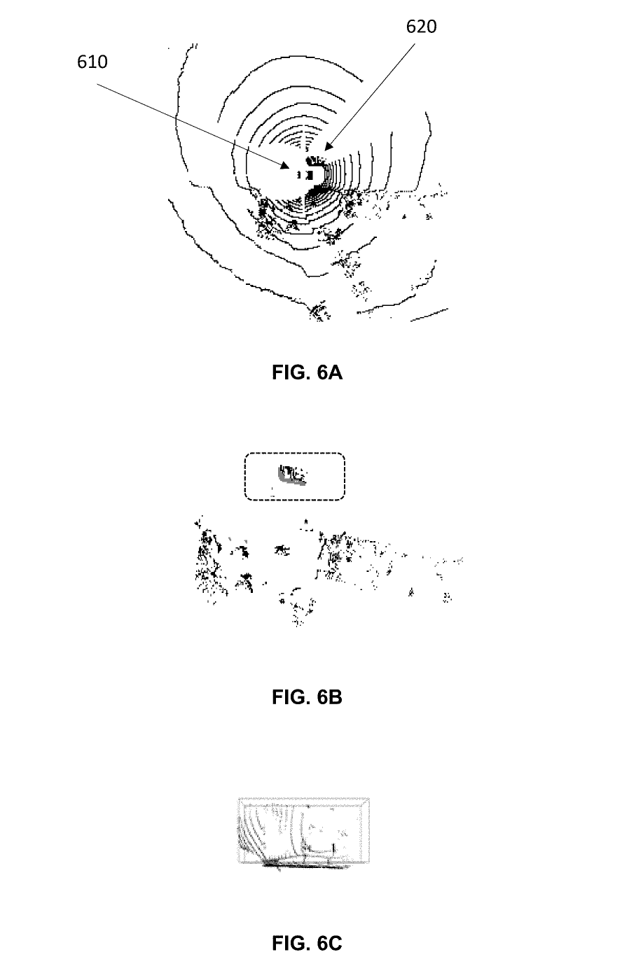

FIGS. 6A-6C are a series of schematic diagrams of generating and marking a 3D shape of an object in LiDAR point cloud image according to some embodiments of the present disclosure As shown in FIG. 6A, a base station (e.g., a rack of the LiDAR point or a vehicle itself) may be mounted on a vehicle 610 to receive a LiDAR point cloud image around the vehicle 610. It can be seen that the laser is blocked at an object 620. The control unit 150 may identify and position the object 620 by a method disclosed in process 500. For example, the control unit 150 may mark the object 620 after identifying and positioning it as shown in FIG. 6B. The control unit 150 may further determine a 3D shape of the object 620 and mark the object 620 in the 3D shape as shown in FIG. 6C.

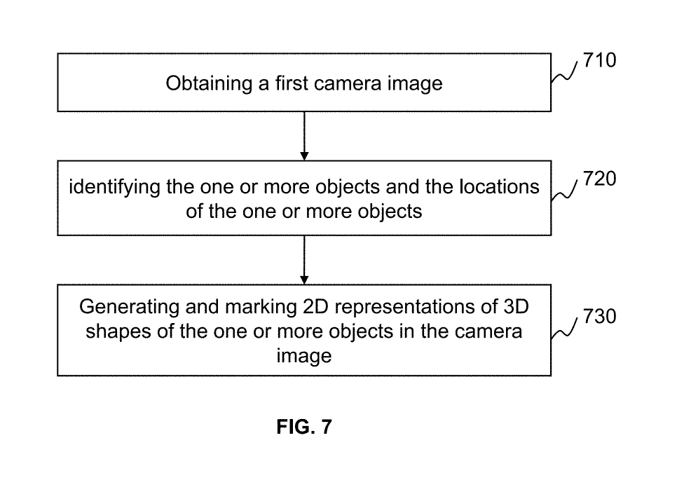

FIG. 7 is a flowchart illustrating an exemplary process for generating a marked camera image according to some embodiments of the present disclosure. In some embodiments, the process 700 may be implemented in the autonomous vehicle as illustrated in FIG. 1. For example, the process 700 may be stored in the storage 220 and/or other storage (e.g., the ROM 330, the RAM 340) as a form of instructions, and invoked and/or executed by a processing unit (e.g., the processor 320, the control unit 150, one or more microchips of the control unit 150). The present disclosure takes the control unit 150 as an example to execute the instruction.

In 710, the control unit 150 may obtain a first camera image. The camera image may be obtained by the camera 410. Merely by way of example, the camera image may be a 2D image, including one or more objects around a vehicle.

In 720, the control unit 150 may identify the one or more objects and the locations of the one or more objects. The identification may be performed based on a neural network. The neural network may include an artificial neural network, a convolutional neural network, a you only look once network, a tiny yolo network, or the like, or any combination thereof. The neural network may be trained by a plurality of camera image samples in which the objects are identified manually or artificially. In some embodiments, the control unit 150 may input the first camera image into the trained neural network and the trained neural network may output the identifications and locations of the one or more objects.

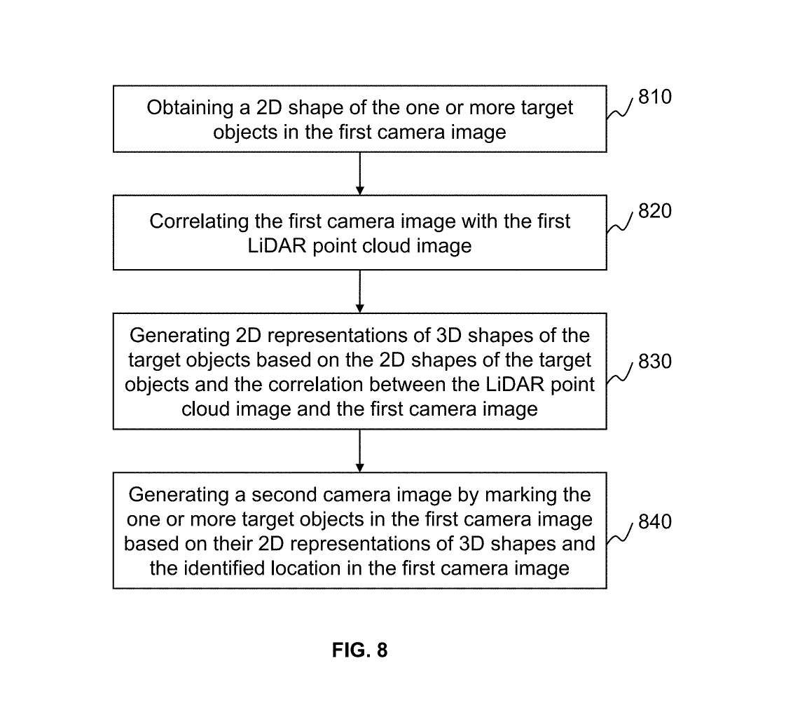

In 730, the control unit 150 may generate and mark 2D representations of 3D shapes of the one or more objects in the camera image. In some embodiments, the 2D representations of 3D shapes of the one or more objects may be generated by mapping 3D shapes of the one or more objects in LiDAR point cloud image to the camera image at the corresponding locations of the one or more objects. Detailed methods regarding the generation of the 2D representations of 3D shapes of the one or more objects in the camera image may be found in FIG. 8.

FIG. 8 is a flowchart illustrating an exemplary process for generating 2D representations of 3D shapes of the one or more objects in the camera image according to some embodiments of the present disclosure. In some embodiments, the process 800 may be implemented in the autonomous vehicle as illustrated in FIG. 1. For example, the process 800 may be stored in the storage 220 and/or other storage (e.g., the ROM 330, the RAM 340) as a form of instructions, and invoked and/or executed by a processing unit (e.g., the processor 320, the control unit 150, one or more microchips of the control unit 150). The present disclosure takes the control unit 150 as an example to execute the instruction.

In step 810, the control unit 150 may obtain a 2D shape of the one or more target objects in the first camera image.

It should be noted that because the camera only captures objects in a limited view whereas the LiDAR scans 360° around the base station, the first camera image may only include part of all the objects in the first LiDAR point cloud image. For brevity, objects that occur in both the first camera image and the first LiDAR point cloud image may be referred to as target objects in the present application. It should also be noted that a 2D shape described in present disclosure may include but not limited to a triangle, a rectangle (also referred to as a 2D box), a square, a circle, an oval, and a polygon. Similarly, a 3D shape described in present disclosure may include but not limited to a cuboid (also referred to as a 3D box), a cube, a sphere, a polyhedral, and a cone. The 2D representation of 3D shape may be a 2D shape that looks like a 3D shape.

The 2D shape of the one or more target objects may be generated by executing a neural network. The neural network may include an artificial neural network, a convolutional neural network, a you only look once (yolo) network, a tiny yolo network, or the like, or any combination thereof. The neural network may be trained by a plurality of camera image samples in which 2D shapes, locations, and types of the objects are identified manually or artificially. In some embodiments, the control unit 150 may input the first camera image into the trained neural network and the trained neural network may output the types, locations and 2D shapes of the one or more target objects. In some embodiments, the neural network may generate a camera image in which the one or more objects are marked with 2D shapes (e.g., 2D boxes) based on the first camera image.

In step 820, the control unit 150 may correlate the first camera image with the first LiDAR point cloud image.

For example, a distance between each of the one or more target objects and the base station (e.g., the vehicle or the rack of the LiDAR device and camera on the vehicle) in the first camera image and the first LiDAR point cloud image may be measured and correlated. For example, the control unit 150 may correlate the distance between a target object and the base station in the first camera image with that in the first LiDAR point cloud image. Accordingly, the size of 2D or 3D shape of the target object in the first camera image may be correlated with that in the first LiDAR point cloud image by the control unit 150. For example, the size of the target object and the distance between the target object and the base station in the first camera image may be proportional to that in the first LiDAR point cloud image. The correlation between the first camera image and the first LiDAR point cloud image may include a mapping relationship or a conversion of coordinate between them. For example, the correlation may include a conversion from a 3D cartesian coordinate to a 2D plane of a 3D spherical coordinate centered at the base station.

In step 830, the control unit 150 may generate 2D representations of 3D shapes of the target objects based on the 2D shapes of the target objects and the correlation between the LiDAR point cloud image and the first camera image.

For example, the control unit 150 may first perform a registration between the 2D shapes of the target objects in the camera image and the 3D shapes of the target objects in the LiDAR point cloud image. The control unit 150 may then generate the 2D representations of 3D shapes of the target objects based on the 3D shapes of the target objects in the LiDAR point cloud image and the correlation. For example, the control unit 150 may perform a simulated conic projection from a center at the base station, and generate 2D representations of 3D shapes of the target objects at the plane of the 2D camera image based on the correlation between the LiDAR point cloud image and the first camera image.

In step 840, the control unit 150 may generate a second camera image by marking the one or more target objects in the first camera image based on their 2D representations of 3D shapes and the identified location in the first camera image.

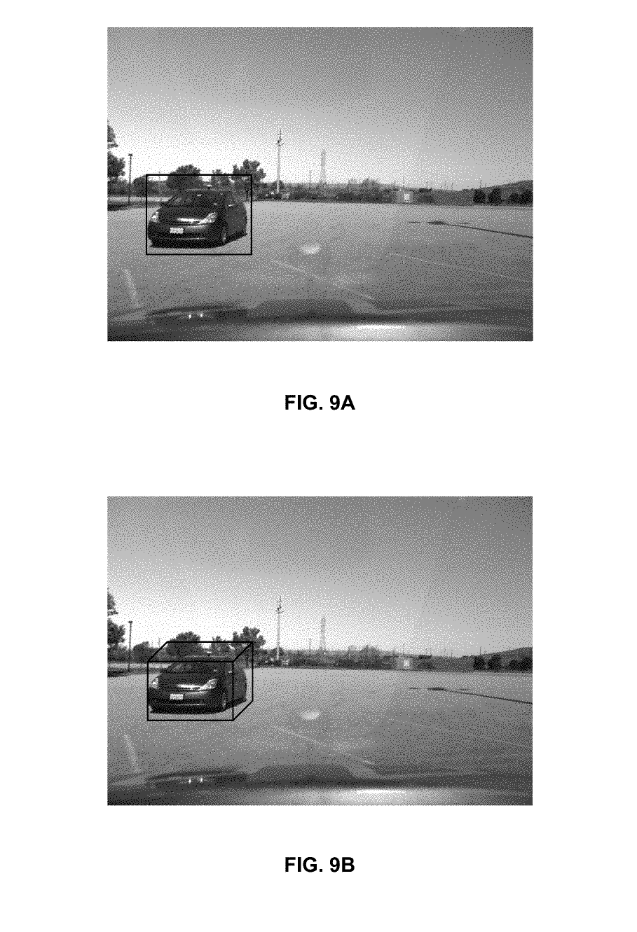

FIGS. 9A and 9B are schematic diagrams of same 2D camera images of a car according to some embodiments of the present disclosure. As shown in FIG. 9A, a vehicle 910 is identified and positioned, and a 2D box is marked on it. In some embodiments, the control unit 150 may perform a method disclosed in present application (e.g., process 800) to generate a 2D representation of a 3D box of the car. The 2D representation of the 3D box of the car is marked on the car as shown in FIG. 9B. Comparing with FIG. 9A, FIG. 9B indicates not only the size of the car but also a depth of car in an axis perpendicular to the plane of the camera image and thus is better in understanding the location of the car.

FIG. 10 is a schematic diagram of a you only look once (yolo) network according to some embodiments of the present disclosure. A yolo network may be a neural network that divides a camera image into regions and predicts bounding boxes and probabilities for each region. The yolo network may be a multilayer neural network (e.g., including multiple layers). The multiple layers may include at least one convolutional layer (CONV), at least one pooling layer (POOL), and at least one fully connected layer (FC). The multiple layers of the yolo network may correspond to neurons arranged multiple dimensions, including but not limited to width, height, center coordinate, confidence, and classification.

The CONV layer may connect neurons to local regions and compute the output of neurons that are connected to local regions in the input, each computing a dot product between their weights and the regions they are connected to. The POOL layer may perform a down sampling operation along the spatial dimensions (width, height) resulting in a reduced volume. The function of the POOL layer may include progressively reducing the spatial size of the representation to reduce the number of parameters and computation in the network, and hence to also control overfitting. The POOL Layer operates independently on every depth slice of the input and resizes it spatially, using the MAX operation. In some embodiments, each neuron in the FC layer may be connected to all the values in the previous volume and the FC layer may compute the classification scores.

As shown in FIG. 10, 1010 may be an initial image in a volume of e.g., [448*448*3], wherein “448” relates to a resolution (or number of pixels) and “3” relates to channels (RGB 3 channels). Images 1020-1070 may be intermediate images generated by multiple CONV layers and POOL layers. It may be noticed that the size of the image reduces and the dimension increases from image 1010 to 1070. The volume of image 1070 may be [7*7*1024], and the size of the image 1070 may not be reduced any more by extra CONV layers. Two fully connected layers may be arranged after 1070 to generate images 1080 and 1090. Image 1090 may divide the original image into 49 regions, each region containing 30 dimensions and responsible for predicting a bounding box. In some embodiments, the 30 dimensions may include x, y, width, height for the bounding box's rectangle, a confidence score, and a probability distribution over 20 classes. If a region is responsible for predicting a number of bounding boxes, the dimension may be multiplied by the corresponding number. For example, if a region is responsible for predicting 5 bounding boxes, the dimension of 1090 may be 150.

A tiny yolo network may be a network with similar structure but fewer layers than a yolo network, e.g., fewer convolutional layers and fewer pooling layers. The tiny yolo network may be based off of the Darknet reference network and may be much faster but less accurate than a normal yolo network.

FIG. 11 is a flowchart illustrating an exemplary process for identifying the objects in a LiDAR point cloud image according to some embodiments of the present disclosure. In some embodiments, the process 1100 may be implemented in the autonomous vehicle as illustrated in FIG. 1. For example, the process 1100 may be stored in the storage 220 and/or other storage (e.g., the ROM 330, the RAM 340) as a form of instructions, and invoked and/or executed by a processing unit (e.g., the processor 320, the control unit 150, one or more microchips of the control unit 150). The present disclosure takes the control unit 150 as an example to execute the instruction.

In 1110, the control unit 150 may obtain coordinates of a plurality of points (or voxels) in the LiDAR point cloud image (e.g., the first LiDAR point image). The coordinate of each of the plurality of points may be a relative coordinate corresponding to an origin (e.g., the base station or the source of the laser beam).

In 1120, the control unit 150 may remove uninterested points from the plurality of points according to their coordinates. In a scenario of using the present application as a driving aid, the uninterested points may be points that are of too low (e.g., ground) position or too high (e.g., at a height that cannot be an object to avoid or to consider when driving) position in the LiDAR point cloud image.

In 1130, the control unit 150 may cluster the remaining points in the plurality of points in the LiDAR point cloud image into one or more clusters based on a point cloud clustering algorithm. In some embodiments, a spatial distance (or a Euclidean distance) between any two of the remaining points in a 3D cartesian coordinate system may be measured and compared with a threshold. If the spatial distance between two points is less than or equal to the threshold, the two points are considered from a same object and clustered into a same cluster. The threshold may vary dynamically based on the distances between remaining points. In some embodiments, the remaining points may be swing scanned before clustered into the plurality of clusters. The swing scanning may include converting the remaining points in the 3D point cloud image from a 3D cartesian coordinate system to a polar coordinate system. The polar coordinate system may include an origin or a reference point. The polar coordinate of each of the remaining points may be expressed as a straight-line distance from the origin, and an angle from the origin to the point. A graph may be generated based on the polar coordinates of the remaining points (e.g., angle from the origin as x-axis or horizontal axis and distance from the origin as y-axis or vertical axis). The points in the graph may be connected to generate a curve that includes sections with large curvatures and sections with small curvatures. Points on a section of the curve with a small curvature are likely the points on a same object and may be clustered into a same cluster. Points on a section of the curve with a large curvature are likely the points on different objects and may be clustered into different clusters. As another example, the point cloud clustering algorithm may include employing a pre-trained clustering model. The clustering model may include a plurality of classifiers with pre-trained parameters. The clustering model may be further updated when clustering the remaining points.

In 1140, the control unit 150 may select at least one of the one or more clusters as a target cluster. For example, some of the one or more clusters are not at a size of any meaningful object, such as a size of a leave, a plastic bag, or a water bottle and may be removed. In some embodiments, only the cluster that satisfies a predetermined size of the objects may be selected as the target cluster.

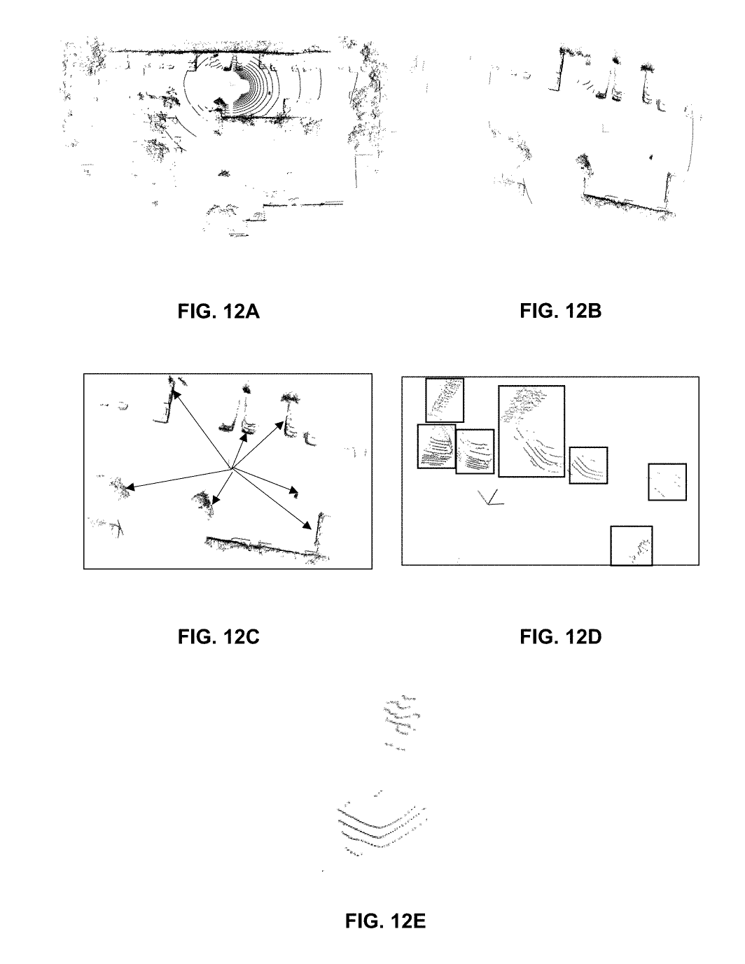

FIGS. 12A-12E are a series of schematic diagrams of identifying an object in a LiDAR point cloud image according to some embodiments of the present disclosure. FIG. 12A is a schematic LiDAR point cloud image around a vehicle 1210. The control unit 150 may obtain the coordinates of the points in FIG. 12A and may remove points that are too low or too high to generate the FIG. 12B. Then the control unit 150 may swing scan the points in the FIG. 12B and measure a distance and angle of each of the points in the FIG. 12B from a reference point or origin as shown in FIG. 12C. The control unit 150 may further cluster the points into one or more clusters based on the distances and angles as shown in FIG. 12D. The control unit 150 may extract the cluster of the one or more clusters individually as shown in FIG. 12E and generate a 3D shape of the objects in the extracted cluster. Detailed methods regarding the generation of 3D shape of the objects in the extracted cluster may be found elsewhere in present disclosure (See, e.g., FIG. 13 and the descriptions thereof).

FIG. 13 is a flowchart illustrating an exemplary process for generating a 3D shape of an object in a LiDAR point cloud image according to some embodiments of the present disclosure. In some embodiments, the process 1300 may be implemented in the autonomous vehicle as illustrated in FIG. 1. For example, the process 1300 may be stored in the storage 220 and/or other storage (e.g., the ROM 330, the RAM 340) as a form of instructions, and invoked and/or executed by a processing unit (e.g., the processor 320, the control unit 150, one or more microchips of the control unit 150). The present disclosure takes the control unit 150 as an example to execute the instruction.

In 1310, the control unit 150 may determine a preliminary 3D shape of the object.

The preliminary 3D shape may be a voxel, a cuboid (also referred to as 3D box), a cube, etc. In some embodiments, the control unit 150 may determine a center point of the object. The center point of the object may be determined based on the coordinates of the points in the object. For example, the control unit 150 may determine the center point as the average value of the coordinates of the points in the object. Then the control unit 150 may place the preliminary 3D shape at the centered point of the object (e.g., clustered and extracted LiDAR point cloud image of the object). For example, a cuboid of a preset size may be placed on the center point of the object by the control unit 150.

Because the LiDAR point cloud image only includes points of the surface of objects that reflect a laser beam, the points only reflects the surface shape of the objects. In an ideal situation without considering error and variations of the points, the distribution of the points of an object may tight along a contour of the shape of the object. No points are inside the contour and no points are outside the contour. In reality, however, because of measurement errors, the points are scattered around the contour. Therefore, a shape proposal may be needed to identify a rough shape of the object for the purpose of autonomous driving. To this end, the control unit 150 may tune up the 3D shape to obtain an ideal size, shape, orientation, and position and use the 3D shape to serve as the shape proposal.

In 1320, the control unit 150 may adjust at least one of parameters including a height, a width, a length, a yaw, or an orientation of the preliminary 3D shape to generate a 3D shape proposal. In some embodiments, the operations 1320 (and operations 1330 and 1340) may be performed iteratively. In each iteration, one or more of the parameters may be adjusted. For example, the height of the 3D shape is adjusted in the first iteration, and the length of the 3D shape is adjusted in the second iteration. As another example, both the height and length of the 3D shape are adjusted in the first iteration, and the height and width of the 3D shape are adjusted in the second iteration. The adjustment of the parameters may be an increment or a decrement. Also, the adjustment of the parameter in each iteration may be same or different. In some embodiments, the adjustment of height, width, length and yaw may be employed based on a grid searching method.

An ideal shape proposal should serve as a reliable reference shape for the autonomous vehicle to plan its driving path. For example, when the autonomous vehicle determines to surpass the object using the shape proposal as the description of the object, the driving path should guarantee that the vehicle can accurately plan its driving path to safely drive around the object, but at the same time operate a minimum degree of turning to left or right to ensure the driving as smooth as possible. As an example result, the shape proposal may not be required to precisely describe the shape of the object, but must be big enough to cover the object so that the an autonomous vehicle may reliably rely on the shape proposal to determine a driving path without colliding and/or crashing into the object. However, the shape proposal may not be unnecessarily big either to affect the efficiency of driving path in passing around the object.

Accordingly, the control unit 150 may evaluate a loss function, which serves as a measure how good the shape proposal is in describing the object for purpose of autonomous driving path planning. The lesser the score or value of the loss function, the better the shape proposal describes the object.

In 1330, the control unit 150 may calculate a score (or a value) of the loss function of the 3D shape proposal. Merely by way of example, the loss function may include three parts: L_{inbox}, L_{suf} and Lₒₜₕₑᵣ. For example, the loss function of the 3D shape proposal may be expressed as follows:

L=(L_{inbox}L_{suf})/N+Lₒₜₕₑᵣ (1)

L_{inbox}=Σ_{P}_{_}ₐₗₗdis (2)

L_{suf}(car)=Σ_{P}_{_}ₒᵤₜm*dis+Σ_{P}_{_}ᵢₙn*dis (3)

L_{suf}(ped)=Σ_{P}_{_}ₒᵤₜa*dis+Σ_{P}_{_}ᵢₙb*dis+Σ_{P}_{_}_{behind}c*dis (4)

Lₒₜₕₑᵣ=f(N)+Lₘᵢₙ(V) (5)

Here L may denote an overall score of the 3D shape proposal, L_{inbox} may denote a score of the 3D shape proposal relating to the number of points of the object inside the 3D shape proposal. L_{suf} may denote a score describing how close the 3D shape proposal is to the true shape of the object, measured by distances of the points to the surface of the shape proposal. Thus a smaller score of L_{suf} means the 3D shape proposal is closer to the surface shape or contour of the object. Further, L_{suf}(car) may denote a score of the 3D shape proposal relating to distances between points of a car and the surface of the 3D shape proposal, L_{suf}(ped) may denote a score of the 3D shape proposal relating to distances between points of a pedestrian and the surface of the 3D shape proposal and Lₒₜₕₑᵣ may denote a score of the 3D shape proposal due to other bonuses or penalties.

Further, N may denote number of points, P__{^{all}} may denote all the points of the object, P__{^{out}} may denote points outside the 3D shape proposal, P__{ⁱⁿ} may denote points inside the 3D shape proposal, P__{^{behind}} may denote points behind the 3D shape proposal (e.g., points on the back side of the 3D shape proposal), and dis may denote distance from the points of the object to the surface of the 3D shape proposal. In some embodiments, m, n, a, b and c are constants. For example, m may be 2.0, n may be 1.5, a may be 2.0, b may be 0.6 and c may be 1.2.

L_{inbox} may be configured to minimize the number of points inside the 3D shape proposal. Therefore, the less the number of points inside, the smaller the score of L_{inbox}. L_{surf} may be configured to encourage certain shape and orientation of the 3D shape proposal so that the points close to the surface of the 3D shape proposal are as much as possible. Accordingly, the smaller the accumulative distances of the points to the surface of the 3D shape proposal, the smaller the score of L_{surf}. Lₒₜₕₑᵣ is configured to encourage a nice and dense cluster of points, i.e., the number of point cluster is larger and the volume of the 3D shape proposal is smaller. Accordingly, f(N) is defined as a function with respect to the total number of points in the 3D shape proposal, i.e., the more points in the 3D shape proposal, the better the loss function, thereby the lesser the score of f(N); and Lₘᵢₙ(V) is defined as a restrain to the volume of the 3D shape proposal, which try to minimize the volume of the 3D shape proposal, i.e., the smaller the volume of the 3D shape proposal, the smaller the score of Lₘᵢₙ(V).

Accordingly, the loss function L in equation (1) incorporates balanced consideration of different factors that encourage the 3D shape proposal to be close to the contour of the object without being unnecessarily big.

In 1340, the control unit 150 may determine whether the score of the 3D shape proposal satisfies a preset condition. The preset condition may include that the score is less than or equal to a threshold, the score doesn't change over a number of iterations, a certain number of iterations is performed, etc. In response to the determination that the score of the 3D shape proposal does not satisfy a preset condition, the process 1300 may proceed back to 1320; otherwise, the process 1300 may proceed to 1360.

In 1320, the control unit 150 may further adjust the 3D shape proposal. In some embodiments, the parameters that are adjusted in subsequent iterations may be different from the current iteration. For example, the control unit 150 may perform a first set of adjustments on the height of the 3D shape proposal in the first five iterations. After finding that the score of the 3D shape proposal cannot be reduced lower than the threshold by only adjusting the height. The control unit 150 may perform a second set of adjustments on the width, the length, the yaw of the 3D shape proposal in the next 10 iterations. The score of the 3D shape proposal may still be higher than the threshold after the second adjustment, and the control unit 150 may perform a third set of adjustments on the orientation (e.g., the location or center point) of the 3D shape proposal. It should be noted the adjustments of parameters may be performed in any order and the number and type of parameters in each adjustment may be same or different.

In 1360, the control unit 150 may determine the 3D shape proposal as the 3D shape of the object (or nominal 3D shape of the object).

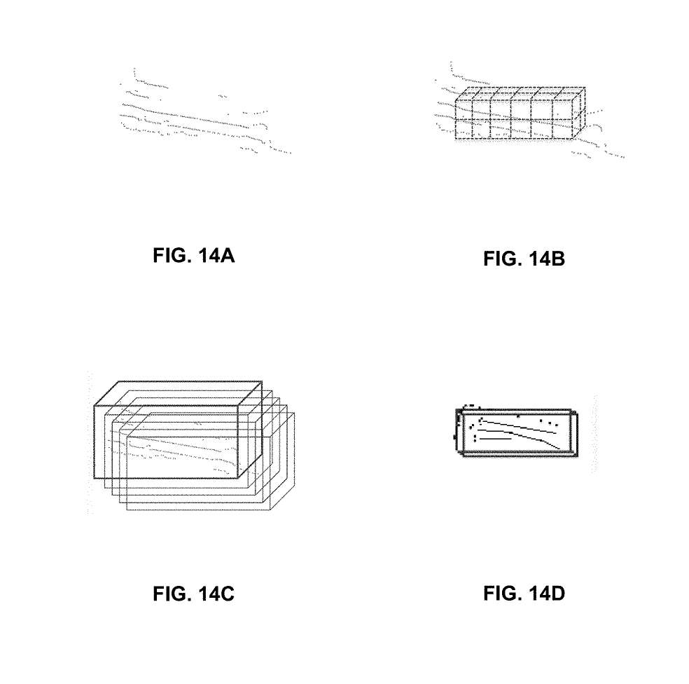

FIGS. 14A-14D are a series of schematic diagrams of generating a 3D shape of an object in a LiDAR point cloud image according to some embodiments of the present disclosure. FIG. 14A is a clustered and extracted LiDAR point cloud image of an object. The control unit 150 may generate a preliminary 3D shape and may adjust a height, a width, a length, and a yaw of the preliminary 3D shape to generate a 3D shape proposal as shown in FIG. 14B. After the adjustment of the height, width, length, and yaw, the control unit 150 may further adjust the orientation of the 3D shape proposal as shown in FIG. 14C. Finally, a 3D shape proposal that satisfies a preset condition as described in the description of the process 1300 may be determined as an 3D shape of the object and may be marked on the object as shown in FIG. 14D.

FIG. 15 is a flow chart illustrating an exemplary process for generating a compensated image according to some embodiments of the present disclosure. In some embodiments, the process 1500 may be implemented in the autonomous vehicle as illustrated in FIG. 1. For example, the process 1500 may be stored in the storage 220 and/or other storage (e.g., the ROM 330, the RAM 340) as a form of instructions, and invoked and/or executed by a processing unit (e.g., the processor 320, the control unit 150, one or more microchips of the control unit 150). The present disclosure takes the control unit 150 as an example to execute the instruction.

In 1510, the control unit 150 may obtain a first radar image around a base station. The first radar image may be generated by the radar device 430. Comparing with the LiDAR device 420, the radar device 430 may be less precise (with less resolution) but may have a wider detection range. For example, a LiDAR device 420 may only receive a reflected laser beam at a reasonable quality from an object within 35 meters. However, the radar device 430 may receive reflected radio waves from an object hundreds of meters away.

In 1520, the control unit 150 may identify the one or more objects in the first radar image. The method of identifying the one or more objects in the first radar image may be similar to that of the first LiDAR point cloud image, and is not repeated herein.

In 1530, the control unit 150 may determine one or more locations of the one or more objects in the first radar image. The method of determining the one or more locations of the one or more objects in the first radar image may be similar to that in the first LiDAR point cloud image, and is not repeated herein.

In 1540, the control unit 150 may generate a 3D shape for each of the one or more objects in the first radar image. In some embodiments, the method of generating the 3D shape for each of the one or more objects in the first radar image may be similar to that in the first LiDAR point cloud image. In some other embodiments, the control unit 150 may obtain dimensions and center point of a front surface each of the one or more objects. The 3D shape of an object may be generated simply by extending the front surface in a direction of the body of the object.

In 1550, the control unit 150 may mark the one or more objects in the first Radar image based on the locations and the 3D shapes of the one or more objects in the first Radar image to generate a second Radar image.

In 1560, the control unit 150 may fuse the second Radar image and the second LiDAR point cloud image to generate a compensated image. In some embodiments, the LiDAR point cloud image may have higher resolution and reliability near the base station than the radar image, and the radar image may have higher resolution and reliability away from the base station than the LiDAR point cloud image. For example, the control unit 150 may divide the second radar image and second LiDAR point cloud image into 3 sections, 0 to 30 meters, 30 to 50 meters, and greater than 50 meters from the base station. The second radar image and second LiDAR point cloud image may be fused in a manner that only the LiDAR point cloud image is retained from 0 to 30 meters, and only the radar image is retained greater than 50 meters. In some embodiments, the greyscale value of voxels from 30 to 50 meters of the second radar image and the second LiDAR point cloud image may be averaged.

FIG. 16 is a schematic diagram of a synchronization between camera, LiDAR device, and/or radar device according to some embodiments of the present disclosure. As shown in FIG. 16, the frame rates of a camera (e.g., camera 410), a LiDAR device (e.g., LiDAR device 420) and a radar device (e.g., radar device 430) are different. Assuming that the camera, the LiDAR device and the radar device start to work simultaneously at a first time frame T1, a camera image, a LiDAR point cloud image, and a radar image may be generated roughly at the same time (e.g., synchronized). However, the subsequent images are not synchronized due to the different frame rates. In some embodiments, a device with slowest frame rate among the camera, the LiDAR device, and the radar device may be determined (In the example of FIG. 16, it's the camera). The control unit 150 may record each of the time frames of the camera images that camera captured and may search for other LiDAR images and radar images that are close to the time of each of the time frames of the camera images. For each of the time frames of the camera images, a corresponding LiDAR image and a corresponding radar image may be obtained. For example, a camera image 1610 is obtained at T2, the control unit 150 may search for a LiDAR image and a radar image that are closest to T2 (e.g., the LiDAR image 1620 and radar image 1630). The camera image and the corresponding LiDAR image and radar image are extracted as a set. The three images in a set is assumed to be obtained at the same time and synchronized.

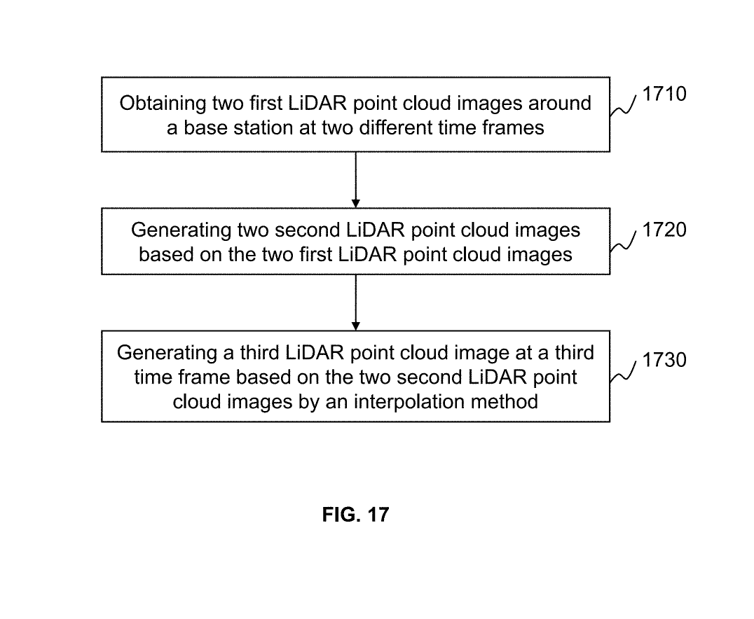

FIG. 17 is a flow chart illustrating an exemplary process for generating a LiDAR point cloud image or a video based on existing LiDAR point cloud images according to some embodiments of the present disclosure. In some embodiments, the process 1700 may be implemented in the autonomous vehicle as illustrated in FIG. 1. For example, the process 1700 may be stored in the storage 220 and/or other storage (e.g., the ROM 330, the RAM 340) as a form of instructions, and invoked and/or executed by a processing unit (e.g., the processor 320, the control unit 150, one or more microchips of the control unit 150). The present disclosure takes the control unit 150 as an example to execute the instruction.

In 1710, the control unit 150 may obtain two first LiDAR point cloud images around a base station at two different time frames. The two different time frames may be taken successively by a same LiDAR device.

In 1720, the control unit 150 may generate two second LiDAR point cloud images based on the two first LiDAR point cloud images. The method of generating the two second LiDAR point cloud images from the two first LiDAR point cloud images may be found in process 500.

In 1730, the control unit 150 may generate a third LiDAR point cloud image at a third time frame based on the two second LiDAR point cloud images by an interpolation method.

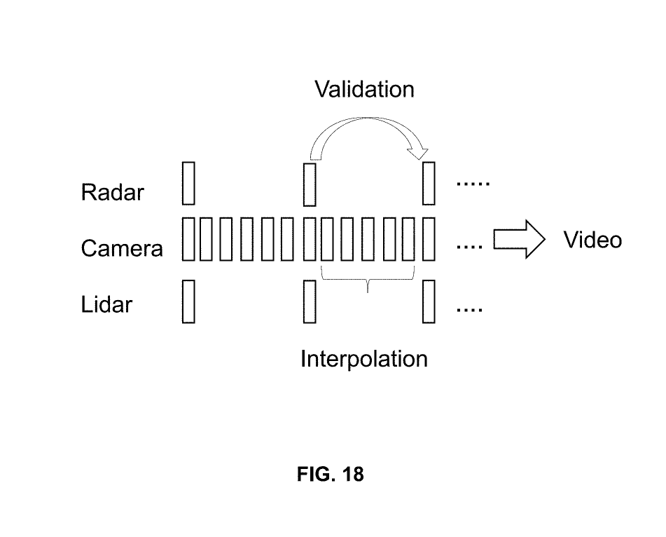

FIG. 18 is a schematic diagram of validating and interpolating frames of images according to some embodiments of the present disclosure. As shown in FIG. 18, the radar images, the camera images, and the LiDAR images are synchronized (e.g., by a method disclosed in FIG. 16). Additional camera images are generated between existing camera images by an interpolation method. The control unit 150 may generate a video based on the camera images. In some embodiments, the control unit 150 may validate and modify each frame of the camera images, LiDAR images and/or radar images based on historical information. The historical information may include the same or different type of images in the preceding frame or previous frames. For example, a car is not properly identified and positioned in a particular frame of a camera image. However, all of the previous 5 frames correctly identified and positioned the car. The control unit 150 may modify the camera image at the incorrect frame based on the camera images at previous frames and LiDAR images and/or radar images at the incorrect frame and previous frames.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electro -magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A system for driving aid, comprising a control unit including:
one or more storage media including a set of instructions for identifying and positioning one or more objects around a vehicle; and
one or more microchips electronically connected to the one or more storage media, wherein during operation of the system, the one or more microchips execute the set of instructions to:
obtain a first Light Detection and Ranging (LiDAR) point cloud image around a detection base station;
identify one or more objects in the first LiDAR point cloud image;
determine one or more locations of the one or more objects in the first LiDAR point cloud image;
generate a 3D shape for each of the one or more objects; and
generate a second LiDAR point cloud image by marking the one or more objects in the first LiDAR point cloud image based on the locations and the 3D shapes of the one or more objects.

2. The system of claim 1, further comprising:
at least one LiDAR device in communication with the control unit to send the first LiDAR point cloud image to the control unit; and
at least one of
at least one camera in communication with the control unit to send a camera image to the control unit, or
at least one radar device in communication with the control unit to send a radar image to the control unit.

3. The system of claim 1, wherein the detection base station is a vehicle; and the system further comprising:
at least one LiDAR device mounted on a steering wheel, a cowl or reflector of the vehicle, wherein the mounting of the at least one LiDAR device includes at least one of an adhesive bonding, a bolt and nut connection, a bayonet fitting, or a vacuum fixation.

4. The system of claim 1, wherein the one or more microchips further:
obtain a first camera image including at least one of the one or more objects;
identify at least one target object of the one or more objects in the first camera image and at least one target location of the at least one target object in the first camera image; and
generate a second camera image by marking the at least one target object in the first camera image based on the at least one target location in the first camera image and the 3D shape of the at least one target object in the second LiDAR point cloud image.

5. The system of claim 4, wherein in marking the at least one target object in the first camera image, the one or more microchips further:
obtain a 2D shape of the at least one target object in the first camera image;
correlate the second LiDAR point cloud image with the first camera image;
generate a 3D shape of the at least one target object in the first camera image based on the 2D shape of the at least one target object and the correlation between the second LiDAR point cloud image and the first camera image;
generate a second camera image by marking the at least one target object in the first camera image based on the identified location in the first camera image and the 3D shape of the at least one target object in the first camera image.

6. The system of claim 4, wherein to identify the at least one target object in the first camera image and the location of the at least one target object in the first camera image, the one or more microchips operate a you only look once (YOLO) network or a Tiny-YOLO network to identify the at least one target object in the first camera image and the location of the at least one target object in the first camera image.

7. The system of claim 1, wherein to identify the one or more objects in the first LiDAR point cloud image, the one or more microchips further:
obtain coordinates of a plurality of points in the first LiDAR point cloud image, wherein the plurality of points includes uninterested points and remaining points;
remove the uninterested points from the plurality of points according to the coordinates;
cluster the remaining points into one or more clusters based on a point cloud clustering algorithm; and
select at least one of the one or more clusters as at least one target cluster, each of the at least one target cluster corresponding to an object.

8. The system of claim 1, wherein to generate a 3D shape for each of the one or more objects, the one or more microchips further:
determine a preliminary 3D shape of the object;
adjust at least one of a height, a width, a length, a yaw, or an orientation of the preliminary 3D shape to generate a 3D shape proposal;
calculate a score of the 3D shape proposal;
determine whether the score of the 3D shape proposal satisfies a preset condition;
in response to the determination that the score of the 3D shape proposal does not satisfy a preset condition, further adjust the 3D shape proposal; and
in response to the determination that the score of the 3D shape proposal or further adjusted 3D shape proposal satisfies the preset condition, determine the 3D shape proposal or further adjusted 3D shape proposal as the 3D shape of the object.

9. The system of claim 8, wherein the score of the 3D shape proposal is calculated based on at least one of a number of points of the first LiDAR point cloud image inside the 3D shape proposal, a number of points of the first LiDAR point cloud image outside the 3D shape proposal, or distances between the points of the first LiDAR point cloud image inside the 3D shape proposal or the points of the first LiDAR point cloud image outside the 3D shape proposal and the 3D shape.

10. The system of claim 1, wherein the one or more microchips further:
obtain a first radio detection and ranging (Radar) image around the detection base station;
identify the one or more objects in the first Radar image;
determine one or more locations of the one or more objects in the first Radar image;
generate a 3D shape for each of the one or more objects in the first Radar image;
generate a second Radar image by marking the one or more objects in the first Radar image based on the locations and the 3D shapes of the one or more objects in the first Radar image; and
fuse the second Radar image and the second LiDAR point cloud image to generate a compensated image.

11. The system of claim 1, wherein the one or more microchips further:
obtain two first LiDAR point cloud images around the base station at two different time frames;
generate two second LiDAR point cloud images at the two different time frames based on the two first LiDAR point cloud images; and
generate a third LiDAR point cloud image at a third time frame based on the two second LiDAR point cloud images by an interpolation method.

12. The system of claim 1, wherein the one or more microchips further:
obtain a plurality of first LiDAR point cloud images around the base station at a plurality of different time frames;
generate a plurality of second LiDAR point cloud images at the plurality of different time frames based on the plurality of first LiDAR point cloud images; and
generate a video based on the plurality of second LiDAR point cloud images.

13. A method implemented on a computing device having one or more storage media storing instructions for identifying and positioning one or more objects around a vehicle, and one or more microchips electronically connected to the one or more storage media, the method comprising:
obtaining a first light detection and ranging (LiDAR) point cloud image around a detection base station;
identifying one or more objects in the first LiDAR point cloud image;
determining one or more locations of the one or more objects in the first LiDAR point image;
generating a 3D shape for each of the one or more objects; and
generating a second LiDAR point cloud image by marking the one or more objects in the first LiDAR point cloud image based on the locations and the 3D shapes of the one or more objects.

14. The method of claim 13, further comprising:
obtaining a first camera image including at least one of the one or more objects;
identifying at least one target object of the one or more objects in the first camera image and at least one target location of the at least one target object in the first camera image; and
generating a second camera image by marking the at least one target object in the first camera image based on the at least one target location in the first camera image and the 3D shape of the at least one target object in the second LiDAR point cloud image.

15. The method of claim 14, wherein the marking the at least one target object in the first camera image further includes:
obtaining a 2D shape of the at least one target object in the first camera image;
correlating the second LiDAR point cloud image with the first camera image;
generating a 3D shape of the at least one target object in the first camera image based on the 2D shape of the at least one target object and the correlation between the second LiDAR point cloud image and the first camera image;
generating a second camera image by marking the at least one target object in the first camera image based on the identified location in the first camera image and the 3D shape of the at least one target object in the first camera image.

16. (canceled)

17. The method of claim 13, wherein the identifying the one or more objects in the first LiDAR point cloud image further includes:
obtaining coordinates of a plurality of points in the first LiDAR point cloud image, wherein the plurality of points includes uninterested points and remaining points;
removing the uninterested points from the plurality of points according to the coordinates;
clustering the remaining points into one or more clusters based on a point cloud clustering algorithm; and
selecting at least one of the one or more clusters as at least one target cluster, each of the at least one target cluster corresponding to an object.

18. The method of claim 13, wherein the generating a 3D shape for each of the one or more objects further includes:
determining a preliminary 3D shape of the object;
adjusting at least one of a height, a width, a length, a yaw, or an orientation of the preliminary 3D shape to generate a 3D shape proposal;
calculating a score of the 3D shape proposal;
determining whether the score of the 3D shape proposal satisfies a preset condition;
in response to the determination that the score of the 3D shape proposal does not satisfy a preset condition, further adjusting the 3D shape proposal; and
in response to the determination that the score of the 3D shape proposal or further adjusted 3D shape proposal satisfies the preset condition, determining the 3D shape proposal or further adjusted 3D shape proposal as the 3D shape of the object.

19. The method of claim 18, wherein the score of the 3D shape proposal is calculated based on at least one of a number of points of the first LiDAR point cloud image inside the 3D shape proposal, a number of points of the first LiDAR point cloud image outside the 3D shape proposal, or distances between the points of the first LiDAR point cloud image inside the 3D shape proposal or the points of the first LiDAR point cloud image outside the 3D shape proposal and the 3D shape.

20. The method of claim 13, further comprising:
obtaining a first radio detection and ranging (Radar) image around the detection base station;
identifying the one or more objects in the first Radar image;
determining one or more locations of the one or more objects in the first Radar image;
generating a 3D shape for each of the one or more objects in the first Radar image;
generating a second Radar image by marking the one or more objects in the first Radar image based on the locations and the 3D shapes of the one or more objects in the first Radar image; and
fusing the second Radar image and the second LiDAR point cloud image to generate a compensated image.

21. (canceled)

22. (canceled)

23. A non-transitory computer readable medium, comprising at least one set of instructions for identifying and positioning one or more objects around a vehicle, wherein when executed by microchips of an electronic terminal, the at least one set of instructions directs the microchips to perform acts of:
obtaining a first light detection and ranging (LiDAR) point cloud image around a detection base station;
identifying one or more objects in the first LiDAR point cloud image;
determining one or more locations of the one or more objects in the first LiDAR point image;
generating a 3D shape for each of the one or more objects; and
generating a second LiDAR point cloud image by marking the one or more objects in the first LiDAR point cloud image based on the locations and the 3D shapes of the one or more objects.
